(19) United States
(12) Patent Application Publication
(10) Pub. No.: US 2025/0291658 A1
(43) Pub. Date: Sep. 18, 2025

(54) WORK SUPPORT SYSTEM, WORK SUPPORT METHOD, AND INFORMATION STORAGE MEDIUM

(71) Applicant: Cybozu, Inc., Tokyo (JP)

(72) Inventors: Yoshiaki YAJIMA, Shiki-shi (JP); Tatsuya SASAKI, Shinshiro-shi (JP); Wataru IIJIMA, Kitamoto-shi (JP); Yuki NAKAJIMA, Tokyo (JP); Kazutoshi NAKANO, Saitama-shi (JP)

(21) Appl. No.: 19/079,495

(22) Filed: Mar. 14, 2025

(30) Foreign Application Priority Data
Mar. 18, 2024 (JP) 2024-042331

(51) Int. Cl. G06F 9/54

(52) U.S. Cl. CPC G06F 9/547

(57) ABSTRACT

Provided is a work support system, which is configured to support work of a user, the work support system including at least one processor configured to: acquire user input information relating to input of the user; generate an API request for a transmission destination API among a plurality of APIs relating to the support of the work based on the user input information and an AI; and transmit the API request to the transmission destination API.

### CROSS-REFERENCE TO RELATED APPLICATION

The present disclosure contains subject matter related to that disclosed in Japanese Patent Application JP 2024-042331 filed in the Japan Patent Office on Mar. 18, 2024, the entire contents of which are hereby incorporated by reference.

### BACKGROUND OF THE INVENTION

### 1. Field of the Invention

The present disclosure relates to a work support system, a work support method, and an information storage medium.

### 2. Description of the Related Art

Hitherto, a work support system using an application programming interface (API) is known. For example, in Japanese Patent Application Laid-open No. 2021-111047, there is described an agent device serving as an information processing device, in which, when it is determined that a user has an intent such as an “intent that allows inquiry about the time of the last train,” a search for a Web API that can be used to execute an action that meets the intent is performed, and when the Web API is found by the search, voice based on a result of the search is output.

For example, in Japanese Patent Application Laid-open No. 2022-184890, there is described a business analytics conversation tool including: a device including a communication channel, a natural language processor (NLP), a fulfillment application program interface (F-API), a database application program interface (D-API), and a business management database, and in this conversational business tool, the NLP receives a user-input from a user through the communication channel, the NLP deduces an intent of the user-input, the NLP communicates the intent to the F-API, the F-API communicates a request for data associated with the intent to a database via the D-API, the D-API communicates the data associated with the intent to the F-API, and the F-API converts the data associated with the intent to a conversational form and sends the conversational form for voice output through the communication channel.

However, the technology of Japanese Patent Application Laid-open No. 2021-111047 is not intended to be used for a work support system in the first place, but merely analyzes the intention of a general user in daily life and inputs the intention of the user to a Web API that matches the intention. For that reason, the technology of Japanese Patent Application Laid-open No. 2021-111047 cannot increase convenience of the user in the work support system. In the technology of Japanese Patent Application Laid-open No. 2022-184890, the intent of the user deduced by the natural language processor is input to one API called “F-API,” and hence the technology is specialized for a dedicated interface called “F-API” that mediates between the NLP and the D-API that operates a database. For that reason, the technology of Japanese Patent Application Laid-open No. 2022-184890 is not versatile enough to accommodate various APIs, and thus cannot increase the convenience of the user.

### SUMMARY OF THE INVENTION

One object of the present disclosure is to increase convenience of a user.

According to at least one aspect of the present disclosure, there is provided a work support system, which is configured to support work of a user, the work support system including at least one processor configured to: acquire user input information relating to input of the user; generate an API request for a transmission destination API among a plurality of APIs relating to the support of the work based on the user input information and an AI; and transmit the API request to the transmission destination API.

### BRIEF DESCRIPTION OF THE DRAWINGS

FIG. 1 is a diagram for illustrating an example of a hardware configuration of a work support system.

FIG. 2 is a view for illustrating an example of a work support screen displayed on a user terminal.

FIG. 3 is a view for illustrating an example of the work support screen displayed on the user terminal.

FIG. 4 is a diagram for illustrating an example of functions implemented in the work support system.

FIG. 5 is a table for showing an example of an API specification information database.

FIG. 6 is a diagram for illustrating an example of an AI used in generation of an API request.

FIG. 7 is a table for showing an example of a work support database.

FIG. 8 is a flow chart for illustrating an example of processing executed in the work support system.

FIG. 9 is a diagram for illustrating an example of functions implemented in a work support system according to modification examples.

FIG. 10 is a diagram for illustrating an example of processing for correction of the API request.

FIG. 11 is a diagram for illustrating an example of processing in which an answer to a user is output in Modification Example 8.

### DESCRIPTION OF THE EMBODIMENTS

### 1. Hardware Configuration

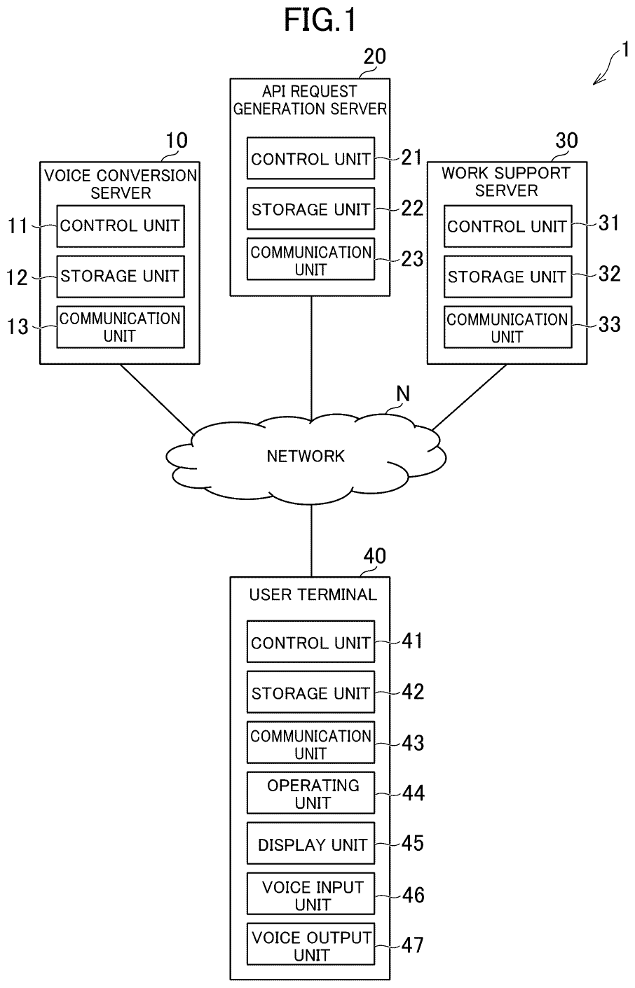

An example of a work support system, a work support method, and a program according to at least one embodiment of the present disclosure is described. FIG. 1 is a diagram for illustrating an example of a hardware configuration of the work support system. For example, a work support system 1 includes a voice conversion server 10, an application programming interface (API) request generation server 20, a work support server 30, and a user terminal 40. Each of the voice conversion server 10, the API request generation server 20, the work support server 30, and the user terminal 40 is connected to a network N such as the Internet or a LAN. One voice conversion server 10, one API request generation server 20, one work support server 30, and one user terminal 40 are illustrated in FIG. 1, but at least one thereof may be provided as two or more components.

The voice conversion server 10 is a server computer that executes voice conversion processing described below. For example, the voice conversion server 10 includes a control unit 11, a storage unit 12, and a communication unit 13. The control unit 11 includes at least one processor. The storage unit 12 includes at least one of a volatile memory such as a RAM, or a non-volatile memory such as a flash memory. The communication unit 13 includes at least one of a communication interface for wired communication or a communication interface for wireless communication.

The API request generation server 20 is a server computer that executes API request generation processing described below. For example, the API request generation server 20 includes a control unit 21, a storage unit 22, and a communication unit 23. Hardware configurations of the control unit 21, the storage unit 22, and the communication unit 23 may be the same as those of the control unit 11, the storage unit 12, and the communication unit 13, respectively.

The work support server 30 is a server computer that executes work support processing described below. For example, the work support server 30 includes a control unit 31, a storage unit 32, and a communication unit 33. Hardware configurations of the control unit 31, the storage unit 32, and the communication unit 33 may be the same as those of the control unit 11, the storage unit 12, and the communication unit 13, respectively.

The user terminal 40 is a computer of a user. For example, the user terminal 40 is a personal computer, a tablet terminal, a smartphone, or a wearable terminal. The user terminal 40 includes a control unit 41, a storage unit 42, a communication unit 43, an operating unit 44, a display unit 45, a voice input unit 46, and a voice output unit 47. Hardware configurations of the control unit 41, the storage unit 42, and the communication unit 43 may be the same as those of the control unit 11, the storage unit 12, and the communication unit 13, respectively. The operating unit 44 includes an input device such as a mouse or a touch panel. The display unit 45 includes a liquid crystal display or an organic EL display. The voice input unit 46 includes at least one microphone. The voice output unit 47 includes at least one speaker.

Programs stored in the storage units 12, 22, 32, and 42 may be supplied via the network N. A hardware configuration of each of the voice conversion server 10, the API request generation server 20, the work support server 30, and the user terminal 40 is not limited to the example of FIG. 1. For example, at least one of the voice conversion server 10, the API request generation server 20, the work support server 30, or the user terminal 40 may include at least one of a reading unit (for example, a memory card slot) that reads a computer-readable information storage medium or an input/output unit (for example, a USB terminal) for directly connecting to an external device. A program stored in the information storage medium may be supplied to at least one of the voice conversion server 10, the API request generation server 20, the work support server 30, or the user terminal 40 through at least one of the reading unit or the input/output unit.

Moreover, the work support system 1 is only required to include at least one computer. The computers included in the work support system 1 are not limited to the example of FIG. 1. For example, the work support system 1 may include only the API request generation server 20 and the work support server 30. In this case, the voice conversion server 10 and the user terminal 40 are present outside the work support system 1. The work support system 1 may include only the API request generation server 20. In this case, the voice conversion server 10, the work support server 30, and the user terminal 40 are present outside the work support system 1. The work support system 1 may include the API request generation server 20 and another server computer.

### 2. Overview of Work Support System

In the at least one embodiment, the work support system 1 can support work of users. Further, in the at least one embodiment, a case in which the work support system 1 can support work of users with no-code or low-code is taken as an example, the work support system 1 can support work of users based on code input by the user. That is, the work support system 1 may be a system that is not classified as a system capable of supporting work of users with no-code or low-code.

The no-code means that the user does not input any code. In other words, the no-code means that the user is not required to input any code to use the work support system 1. The low-code means that the user inputs only minimum required code. In other words, the user is only required to input the minimum required code to use the work support system 1.

The code refers to a command for a computer. In other words, the code refers to information for a computer to understand an instruction of the user. The code may be any code used in the field of computer software. For example, the code may be a programming language code, a cascading style sheets (CSS) code, a database language code, a markup language code, or another code. Programming languages also include languages called scripting languages. The code in the at least one embodiment may be any one of various codes that a person skilled in the field of computer software calls code.

The work support system 1 being able to support work of users with no-code means that the work support system 1 can execute work support processing described below based on code provided in advance even when the user does not input any code. The work support system 1 being able to support work of users with low-code means that, as long as the user inputs only the minimum required code, the work support system 1 can execute the work support processing described below based on the minimum required code input by the user and the code provided in advance.

The meaning of each of the terms “no-code” and “low-code” may be a commonly known meaning. A person skilled in the field of computer software can understand the meaning of each of the no-code and the low-code based on the common general technical knowledge at the time of filing. Each of the no-code and the low-code may have a publicly-known meaning that a person skilled in the art can understand based on the common general technical knowledge at the time of filing. For example, an amount of the minimum required code for the low-code may be an amount that a person skilled in the art can understand based on the common general technical knowledge at the time of filing. For example, the amount of the minimum required code for the low-code may be about 1 line to 100 lines, or may be 101 lines or more.

For example, the work support system 1 has various work support functions for supporting work of users. The work support function is a function implemented by a program developed for work support. Types of work support functions may be publicly-known types. For example, the work support function may be a database function for the user to store data in a database, a communication function for the user to communicate with another user, a schedule function for the user to manage a schedule, an email management function for the user to manage emails, or another function.

In the at least one embodiment, a case in which the work support system 1 provides users with groupware of a cloud type is taken as an example. The work support system 1 may provide users with groupware of an on-premises type. The work support system 1 may provide users with a service that is not classified as groupware but supports work. For example, an organization such as a corporation to which users belong contracts with the work support system 1. As a member of the organization, each user uses the work support function of the work support system 1. When the user logs in to the work support system 1 from a browser of the user terminal 40, the user terminal 40 displays, on the display unit 45, a work support screen for the user to use the work support function. The work support screen may be displayed on a program dedicated to the work support system 1 instead of being displayed on a browser.

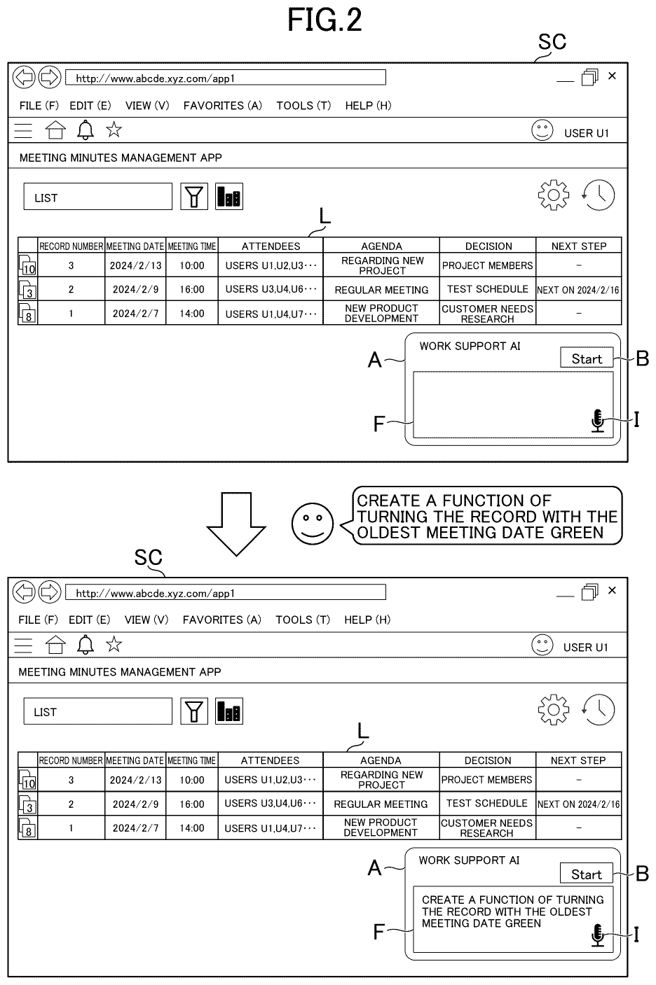

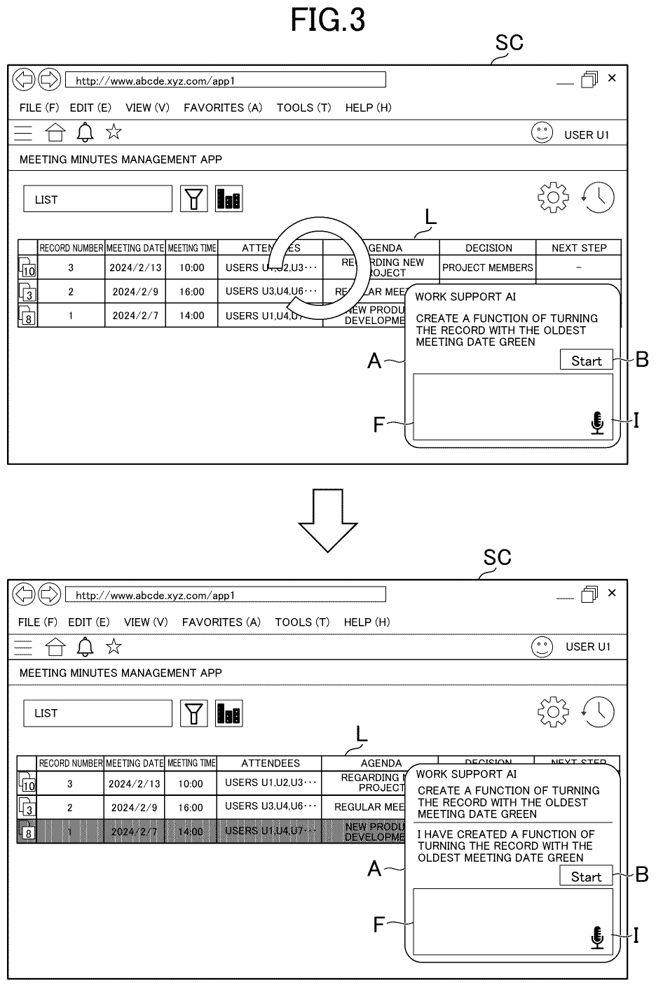

FIG. 2 and FIG. 3 are diagrams for illustrating examples of the work support screen displayed on the user terminal 40. In the at least one embodiment, a case in which the user uses a database function is taken as an example. For example, the user uses an app that is a type of database. The user can store, in the app, any data relating to his or her own work. For example, the user can store, in the app, not only data stored in fields of the app but also other data. For example, the user can store, in the app, comments on other users, files such as documents or images, or other data. The app can be said to be a complex work support function that combines not only the database function but also a communication function and a file management function.

For example, when the user selects the app, the user terminal 40 displays, on the display unit 45, a work support screen SC indicating a list L of records that are units of data that forms the app as in the upper half of FIG. 2. In the example in the upper half of FIG. 2, records of a meeting minutes management app for the user to manage meeting minutes are shown in the list L. When the user selects a record in the list L, the user terminal 40 displays details of the record on the work support screen SC. For example, the user can update the record from the work support screen SC.

In the at least one embodiment, the user can create an app with no-code or low-code. For example, the user can create an app by performing only a simple setting task such as a field setting even without inputting any code. The user can use a default app provided in advance even without performing a setting task. The user can extend the work support function of the app by inputting the minimum required code. That is, the user can create a low-code app by extending the work support function of the app created with no-code. The extension of the work support function can also be said to be customization of the work support function.

For example, the user may extend the function of the app by inputting a script to be executed by the browser of the user terminal 40. The script is a code written in a scripting language. The user may extend the function of the app by inputting a cascading style sheets (CSS) code. The work support system 1 may be compatible with another code other than the script and the CSS. For example, the user inputs code for changing the operation or appearance on a screen. The user may cause an artificial intelligence (AI) described later to generate code.

For example, code for the extension of the function of the app is uploaded to the work support server 30 and deployed to the app. In the at least one embodiment, the work support server 30 executes a series of processing such as deployment of the code based on a code execution API that is an API for deploying the code to the app and executing the code. The API is an interface for linking a plurality of programs (applications) to each other. The API can also be an interface for a certain program (a certain application) to call up another program (another application). A mechanism of the API may be a publicly-known mechanism.

In the at least one embodiment, various APIs for supporting work of users are provided. For each individual API, specifications specific to the API are defined. Examples defined for the API include various specifications such as specifications of an event, specifications for registration or deletion of an event handler, specifications for execution of another API (for example, an API for data linkage), specifications for acquisition or setting of information, specifications for control of display or non-display of information such as a field, specifications relating to a plug-in, or other specifications. The specifications of the API may be publicly-known specifications. For example, the specifications of the API may be published on a website or the like of the work support system 1.

The API is not limited to the code execution API. For example, the work support server 30 can execute a data linkage API for data linkage. As the data linkage API, there may be an API for at least one of acquisition, registration, updating, or deletion of a record, an API for at least one of uploading or downloading of data other than the record, an API for at least one of acquisition, changing, or deletion of information such as app settings, or another API. In addition, for example, there may be an API for another work support function (for example, an API for a communication function, an API for a schedule function, or an API for an email management function) other than the app.

For example, when the user is to create an API request by himself or herself, the user creates an API request in such a manner as to satisfy the specifications defined for the API. The API request is information for requesting predetermined processing. The API request is also called an API call. The API request can also be said to be API input information that is input to the API. For example, the API request includes code indicating content of processing requested by the API request. For that reason, the API request can be said to be a type of code. The API request is transmitted from a client (for example, the user terminal 40 or another computer) to an API endpoint.

In the at least one embodiment, a case in which the API endpoint is the work support server 30 is taken as an example. When the work support system 1 includes a plurality of work support servers 30, the API endpoint is one of the plurality of work support servers 30. The API endpoint may be another computer other than the work support server 30. For example, the API endpoint may be the voice conversion server 10, or may be a computer provided outside the work support system 1. The API endpoint is also one of the specifications of the API. When the user is to create an API request by himself or herself, the user is required to be aware of various specifications.

However, it is difficult for a user with no knowledge of APIs or little knowledge of APIs to create an API request while being aware of the specifications of an API. Even when the user has knowledge of APIs, extremely much time and labor are required to grasp the specifications of an API to be used by the user himself or herself among a large number of APIs. In view of this, the work support system 1 according to the at least one embodiment has an API request generation function of generating an API request through use of an AI. The API request generation function is a type of work support function.

The API request generation function may be a default function (function that can be used by all users from the beginning) of the work support system 1, but in the at least one embodiment, is assumed to be a plug-in that can be freely added by the user. The user who wishes to use the API request generation function adds the API request generation function by the plug-in. The plug-in is a collection of programs and data for the API request generation function. When the user adds the plug-in, the user can use the programs and data for the API request generation function.

The AI is a program having artificial intelligence that supports work of users. There are various views in terms of definitions of the AI, but the AI in the at least one embodiment may be an AI defined by any one of various publicly-known definitions. The AI may be an AI called a generative AI or a conversational AI. Examples of the AI may include a large language model, a machine learning model not classified as a large language model, a program called a bot, or other programs. There are also various views in terms of definitions of machine learning, but the machine learning in the at least one embodiment may be machine learning defined by any one of various publicly-known definitions. The machine learning may be any one of supervised learning, semi-supervised learning, or unsupervised learning.

In the at least one embodiment, a case in which a large language model corresponds to the AI is taken as an example. In addition, an API request for a code execution API is described as an example of the API request. For example, the user uses text (characters) or voice to give an instruction to the AI. In the example in the upper half of FIG. 2, the user selects an icon I for starting voice input, and speaks content of the function with which to extend the app. When the voice input unit 46 detects the voice of the user, the user terminal 40 executes, between the user terminal 40 and the voice conversion server 10, processing for converting the voice of the user into text. When the voice of the user is converted into text, as in the lower half of FIG. 2, the user terminal 40 displays the text in an input form F. When the text is incorrect, the user can correct the text by operating the operating unit 44. The user can also manually input text in the input form F without using the voice input.

In the example in the lower half of FIG. 2, the user gives an instruction such as “Create a function of turning the record with the oldest meeting date green.” For example, in order to extend the function of the app so as to satisfy the instruction of the user, the work support system 1 is required to generate code indicating processing for identifying the record with the oldest meeting date and processing for changing a color of the record. The work support system 1 causes the AI to generate the code. For example, when the user selects a button B, the API request generation server 20 uses the AI to generate an API request for the execution of code that meets the instruction of the user. As in the upper half of FIG. 3, the work support screen SC is in a state waiting for the generation of an API request. The instruction input by the user is displayed in a display region A of the work support screen SC.

For example, the API request generation server 20 transmits the API request generated through use of the AI to the work support server 30 serving as the API endpoint of the code execution API. The work support server 30 receives the API request from the API request generation server 20. The work support server 30 executes the processing requested by the API request based on the code execution API. For example, the work support server 30 executes processing for deploying the code for the extension of the function, which has been input in the input form F, to the app as the processing.

For example, when the code deployed to the app is a script to be executed by the browser of the user terminal 40, the user terminal 40 receives the code from the work support server 30, and executes the code by the browser. When the code that meets the wish of the user is deployed to the app, the user terminal 40 can execute the code to turn the record with the oldest meeting date among the records displayed in the list L green as in the lower half of FIG. 3. An answer from the AI is displayed in the display region A of the work support screen SC. When the user performs an operation for ending the generation of the API request, the code deployed to the app is ultimately reflected in the app. When the user does not perform the operation, the code deployed to the app is discarded.

As described above, when the user inputs an instruction to the AI, the API request generation server 20 generates an API request that meets the instruction. The API request generation server 20 transmits the API request to the work support server 30. The work support server 30 executes the processing requested by the API request. This enables the user to have processing that meets his or her own instruction executed by inputting the instruction in a natural language even without being aware of the specifications of the API, and hence the work support system 1 can increase convenience of the user. Details of the work support system 1 are described below.

### 3. Functions Implemented in Work Support System

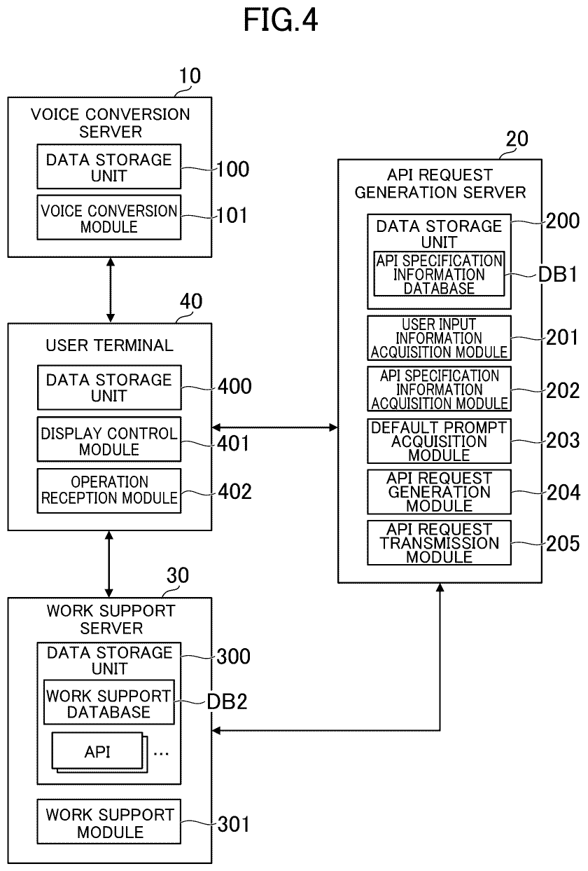

FIG. 4 is a diagram for illustrating an example of functions implemented in the work support system 1.

### 3-1. Functions Implemented in Voice Conversion Server

For example, the voice conversion server 10 includes a data storage unit 100 and a voice conversion module 101. The data storage unit 100 is implemented by the storage unit 12. The voice conversion module 101 is implemented by the control unit 11. When voice input is not performed, the work support system 1 is not required to include the voice conversion server 10.

### [Data Storage Unit]

The data storage unit 100 stores data required for the voice conversion processing. For example, the data storage unit 100 stores a voice conversion program indicating the voice conversion processing. The voice conversion processing is at least one of processing for converting voice into text or processing for converting text into voice. In the at least one embodiment, a case in which the voice conversion processing includes both of those kinds of processing is taken as an example, but the voice conversion processing may be only any one of those kinds of processing. The voice conversion program for converting voice into text and the voice conversion program for converting text into voice may be separately provided. The voice conversion program may be a publicly-known program. For example, the voice conversion program may be a program of a pattern matching method using a voice waveform pattern, a machine learning method, or another method.

### [Voice Conversion Module]

The voice conversion module 101 executes the voice conversion processing based on the voice conversion program. For example, the voice conversion server 10 acquires input voice data indicating voice input by the user from the user terminal 40. A data format of the input voice data may be a publicly-known format. The voice conversion module 101 converts the voice input by the user into text based on the voice data and the voice conversion program. The voice conversion module 101 transmits input text data indicating text of the voice input by the user to the user terminal 40. The voice conversion module 101 may transmit the input text data to the API request generation server 20, the work support server 30, or another computer.

For example, the voice conversion module 101 acquires answer text data indicating text of an answer from the AI from the API request generation server 20, the work support server 30, or another computer. The voice conversion module 101 converts the text of the answer from the AI into voice based on the answer text data and the voice conversion program. The voice conversion module 101 transmits answer voice data indicating voice of the text of the answer from the AI to the user terminal 40. The user terminal 40 acquires the answer voice data from the voice conversion server 10. The user terminal 40 outputs the answer from the AI by voice from the voice output unit 47 based on the answer voice data. The user terminal 40 may acquire the answer text data from the voice conversion server 10, the API request generation server 20, the work support server 30, or another computer. The user terminal 40 may display the answer from the AI in the display region A of the work support screen SC based on the answer text data.

### 3-2. Functions Implemented in API Request Generation Server

For example, the API request generation server 20 includes a data storage unit 200, a user input information acquisition module 201, an API specification information acquisition module 202, a default prompt acquisition module 203, an API request generation module 204, and an API request transmission module 205. The data storage unit 200 is implemented by the storage unit 22. Each of the user input information acquisition module 201, the API specification information acquisition module 202, the default prompt acquisition module 203, the API request generation module 204, and the API request transmission module 205 is implemented by the control unit 21.

### [Data Storage Unit]

The data storage unit 200 stores data required for the API request generation processing for generating an API request. For example, the data storage unit 200 stores an API specification information database DB1.

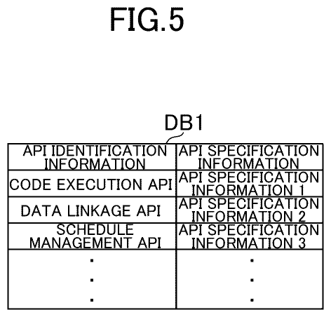

FIG. 5 is a table for showing an example of the API specification information database DB1. For example, the API specification information database DB1 stores API identification information and API specification information. The API identification information is information that can identify each individual API. The API identification information may be a name of the API, an ID assigned to the API, a URL, an IP address, or other information. The API identification information may be information that can identify the API endpoint.

The API specification information is information relating to the specifications of the API. The specification of the API can also be said to be a guideline for the API. For example, the API specification information indicates an HTTP method and a URL (for example, a URL indicating a location at which settings described in a markup language such as JSON are stored) for processing such as acquisition of a record, a method of describing an event, an event type, details of a timing at which an event occurs, restrictions on the API, a format of data to be operated, a method of describing a query to be used for narrowing down data, specifications of coding relating to the API (for example, a character code to be used in coding, a format of variables, a format of attributes, and details of security), or other specifications. The specifications indicated by the API specification information may be specifications employed in a publicly-known service.

In the at least one embodiment, the specifications of the API are described in a natural language so that the AI, which is a large language model, can recognize the specifications of the API. The API specification information may have any data format. For example, the API specification information may be a text file, a rich text file, a document file, or an HTML file, or may have another format. The API specification information may be described in a language that can be understood by a computer instead of a natural language that can be understood by a human. The API specification information may be the same as information that has been published to users on the website of the work support system 1, or may be information different from the published information. The API specification information may be processed so as to be easily recognized by the AI. The API specification information may include another element such as a table or a drawing in addition to the text.

The data stored in the data storage unit 200 is not limited to the above-mentioned example. The data storage unit 200 can store any data. For example, the data storage unit 200 may store information (for example, a URL or an IP address) that can identify the API endpoint of each of a plurality of APIs. The data storage unit 200 may store a template database described later and a default prompt described later.

In the at least one embodiment, a case in which the API request generation server 20 uses the AI of an external service that cooperates with the work support system 1 is taken as an example, and hence it is assumed that the data storage unit 200 does not store the AI itself, but the data storage unit 200 may store the AI itself. That is, in the at least one embodiment, a case in which actual data of the AI is stored in a system for another service is taken as an example, but the data storage unit 200 may store the actual data of the AI.

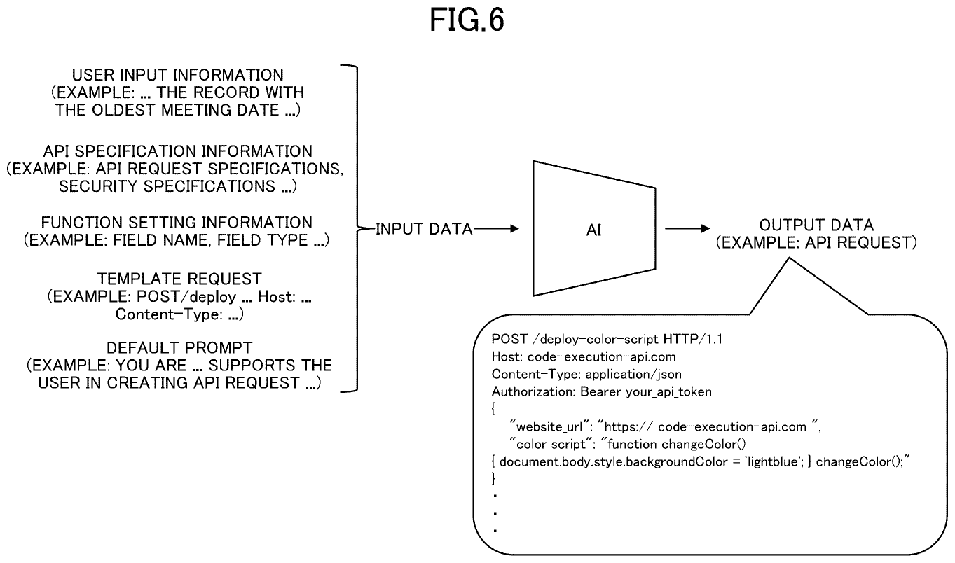

FIG. 6 is a diagram for illustrating an example of an AI used in generation of an API request. For example, the AI includes: a program indicating a series of processing steps such as calculation of an embedded representation; and parameters to be referred to by the program. The embedded representation is information for the AI to understand the meaning of data. For example, the embedded representation is represented by a multidimensional vector. The embedded representation may also be called a feature amount indicating a feature of data. The embedded representation may be represented in another format other than the multidimensional vector. The AI may include other data (for example, data equivalent to a dictionary of terms) other than the parameters. The other data is referred to by the program. The other data may be data separate from the AI. The AI calculates the embedded representation of input data input to itself based on the parameters, and performs output corresponding to the embedded representation. For example, the parameters are weights and biases.

The program and parameters of the AI may be a publicly-known program and publicly-known parameters, respectively. For example, the program and parameters of the AI may be a program and parameters employed in a large language model, such as a generative pre-trained transformer (GPT) or bidirectional encoder representations from transformers (BERT), a program and parameters employed in a machine learning model, such as a neural network or generative adversarial networks (GAN), a program and parameters employed in a generative AI or a conversational AI that is not classified into those, or another program and other parameters. The program and parameters of the AI may be selected from various programs and parameters that can be understood by a person skilled in the field of computer software based on the common general technical knowledge at the time of filing.

In the at least one embodiment, a large language model (for example, GPT) is described as an example of the AI, and hence the program of the AI indicates processing for analyzing input data input to the AI. The parameters of the AI are parameters such as weights and biases that are referred to by the AI to analyze the meaning in a natural language. The AI performs language analysis on the input data input to itself based on the parameters adjusted by training, and performs output corresponding to a result of the language analysis. For example, the AI divides the text in a natural language indicated by the input data into a plurality of tokens. The AI calculates the embedded representations indicating the meanings of the individual tokens based on the parameters. The AI understands the meaning in a natural language based on a sequential order of the embedded representations of the respective tokens. The AI may make a prediction based on the sequential order of the embedded representations of the respective tokens as required. The AI outputs output data corresponding to the sequential order of the embedded representations.

In the at least one embodiment, a case in which various codes (for example, API requests that serve as samples) have been learned by the AI is taken as an example. The AI may learn only a code (for example, JavaScript (trademark)) that can be handled by the work support system 1, but in the at least one embodiment, it is assumed that other codes have been learned as well. The AI may be capable of handling codes in various languages. For example, the output data from the AI may differ depending on the input data. When the input data is some question, the output data indicates an answer to the question. When the input data is an instruction to generate code, the output data includes the code. In this case, the output data may include not only the code but also an explanation of the code. The output data may include any type of information. For example, the AI may generate code based on a publicly-known function called a code interpreter that generates code from learning results in various languages.

As in FIG. 6, in the at least one embodiment, a case in which the input data to the AI includes user input information, API specification information, function setting information, a template request, and a default prompt is taken as an example. Details of those pieces of information included in the input data are described later. The input data is only required to include at least the user input information. The input data is not limited to the example in the at least one embodiment. For example, at least one of the API specification information, the function setting information, the template request, or the default prompt may not be included in the input data. Even when the API specification information is not included in the input data, the AI can generate an API request that meets the API specifications as long as the AI has learned the API specification information in advance.

In the at least one embodiment, a case in which the output data includes the API request is taken as an example. For example, the output data may include code of the API request or the like and information (for example, the answer from the AI) other than the code. The output data from the AI may not include the code of the API request or the like but may include intermediate code to be used to generate code that is ultimately provided to the user. The output data may not include the API request. When the output data does not include the API request, the API request generation module 204 described later generates an API request based on the output data. For example, when the output data includes only code such as a script generated by the AI, the API request generation module 204 may generate an API request for the execution of the code based on the output data that is the code such as a script generated by the AI. In this case, it is assumed that a default API request is stored in the data storage unit 200. The API request generation module 204 may generate a final API request by inserting the content of the output data output by the AI into the default API request.

### [User Input Information Acquisition Module]

The user input information acquisition module 201 acquires user input information relating to the input of the user. In the at least one embodiment, a case in which the user inputs voice from the voice input unit 46 is taken as an example, but the user may also perform the input from the operating unit 44. For example, the user may input an instruction to the AI from the operating unit 44. The user may perform the input by selecting a part (for example, an image such as a button or a check box) serving as a user interface.

The user input information is an instruction to the AI. The user input information can also be said to be an intention of the user. The user input information may also be called a prompt for the AI. Among the pieces of information included in the input data, other pieces of information other than the user input information can also be said to be supplementary information to be input to the AI together with the prompt. There are various definitions of the term “prompt,” but when the information to be input to the AI corresponds to a prompt, other pieces of information other than the user input information also correspond to prompts. The definition of the term “prompt” may be any one of various publicly-known definitions.

For example, the user inputs content relating to processing that the user wishes to execute through use of the API. The user input information indicates the content. The user can input any content. In the at least one embodiment, the user does not code an API request by himself or herself, but generates an API request through use of the AI, and hence the user inputs content relating to the processing to be requested by the API request.

In the example of FIG. 2, the user inputs extension content of the work support function exemplified by the app, and hence the user input information acquisition module 201 acquires user input information relating to the extension content of the work support function in the work support system 1 based on the input of the user. In the at least one embodiment, the AI is used for the extension of the work support function, and hence the user input information indicates content with which the user wishes to extend the work support function (content of customization that the user wishes). The user input information is written in a natural language, but may be information in which the meaning in a natural language is vectorized.

The user input information may indicate content that does not particularly relate to the extension of the work support function. For example, the user input information may indicate data that the user wishes to acquire, data that the user wishes to update, a person with whom the user wishes to communicate, an app that the user wishes to newly create, or other content. The user input information may be any information that relates to content of processing to be requested from the work support system 1 by the user.

In the at least one embodiment, a case in which the text input in the input form F when the user selects the button B corresponds to the user input information is taken as an example. Thus, the user input information is text indicating the content relating to the processing that the user wishes to execute through use of the API. When the user selects the button B, the user terminal 40 transmits the user input information, which is the text input in the input form F, to the API request generation server 20. The user input information acquisition module 201 acquires the user input information from the user terminal 40. The user input information acquisition module 201 may acquire only one piece of user input information, or may acquire a plurality of pieces of user input information.

The user input information may not be text in a natural language but may be the voice itself that has been used in the input by the user. In this case, the user input information acquisition module 201 may acquire the user input information, which is the voice, from the user terminal 40 and then request the voice conversion server 10 to convert the user input information into text. The user input information acquisition module 201 acquires the user input information converted into text from the voice conversion server 10. In the at least one embodiment, the AI is a large language model, and hence the information converted into text is input to the AI. The user input information acquisition module 201 may acquire the user input information indirectly through the voice conversion server 10, the work support server 30, or another computer, instead of acquiring the user input information directly from the user terminal 40.

### [API Specification Information Acquisition Module]

The API specification information acquisition module 202 acquires API specification information relating to specifications of a transmission destination API. The transmission destination API is an API to which an API request is to be transmitted among a plurality of APIs. The transmission destination API can also be said to be an API that receives the API request (that is, an API indicated by the API endpoint), or an API that executes the API request, among the plurality of APIs. In the at least one embodiment, a case in which the API request and the transmission destination API have a one-to-one correspondence is taken as an example, but the API request and the transmission destination API may have a one-to-many correspondence, a many-to-one correspondence, or a many-to-many correspondence.

In the at least one embodiment, the API specification information is stored in the API specification information database DB1, and hence the API specification information acquisition module 202 acquires the API specification information from the API specification information database DB1. The API specification information acquisition module 202 may acquire the API specification information from another database other than the API specification information database DB1, another computer other than the API request generation server 20, or an external information storage medium. The API specification information acquisition module 202 may acquire only one piece of API specification information, or may acquire a plurality of pieces of API specification information.

For example, the API specification information acquisition module 202 may acquire all pieces of API specification information stored in the API specification information database DB1. In the at least one embodiment, the API specification information acquisition module 202 acquires some pieces of API specification information among all the pieces of API specification information stored in the API specification information database DB1. For example, the API specification information acquisition module 202 acquires the API specification information corresponding to a screen that was displayed on the user terminal 40 when the user input information was input. In the examples of FIG. 2 and FIG. 3, the work support screen SC indicating the app is displayed on the user terminal 40, and hence the API specification information acquisition module 202 acquires the API specification information relating to the app (for example, the API specification information on the code execution API) among all the pieces of API specification information.

It is assumed that the data storage unit 200 stores acquisition target data indicating a relationship between the work support screen SC to be displayed on the user terminal 40 and the API specification information to be acquired by the API specification information acquisition module 202. The acquisition target data may have any format, for example, a table format, a mathematical expression format, part of a program, a machine learning model, or another format. In the examples of FIG. 2 and FIG. 3, the acquisition target data is associated with the work support screen SC indicating the app and the API specification information on the code execution API.

For example, the acquisition target data may be associated with the work support screen SC of a thread or the like to be used in the communication function and an API for the communication function. The acquisition target data may be associated with the work support screen SC of a calendar or the like to be used in the schedule function and an API for the schedule function. The acquisition target data may be associated with the work support screen SC for the email management function of a received email list and the like to be used in the email management function and an API for the email management function. The acquisition target data may be associated with the work support screen SC indicating a processing result of another work support function and an API for the other work support function.

For example, the API request generation server 20 acquires display screen information that can identify the currently displayed screen from the user terminal 40. The display screen information may also have any format, and may be, for example, a URL of the currently displayed screen, an ID assigned to the currently displayed screen, or other information. The API specification information acquisition module 202 acquires the API specification information associated with the screen indicated by the display screen information based on the acquisition target data. In the examples of FIG. 2 and FIG. 3, the display screen information indicates the work support screen SC of the app, and hence the API specification information acquisition module 202 acquires the API specification information on the code execution API based on the acquisition target data. Even when another work support screen SC is displayed on the user terminal 40, the API specification information acquisition module 202 similarly acquires API specification information associated with the work support screen SC indicated by the display screen information based on the acquisition target data.

It suffices that the acquisition target data indicates the API specification information to be acquired. The API specification information acquisition module 202 may identify the API specification information to be acquired, not based on the work support screen SC currently displayed on the user terminal 40, but based on another element. For example, the API specification information acquisition module 202 may identify the API specification information to be acquired, based on the user input information. In this case, the acquisition target data indicates a relationship between the user input information and the API specification information to be acquired. The API specification information acquisition module 202 may identify the API specification information to be acquired, based on the user input information and the acquisition target data, and acquire the API specification information. When the user selects the API by himself or herself, the API specification information acquisition module 202 may acquire the API specification information on the API selected by the user without particularly using the acquisition target data.

### [Default Prompt Acquisition Module]

The default prompt acquisition module 203 acquires a default prompt relating to the generation of an API request, the default prompt being provided in advance. In the at least one embodiment, a case in which the default prompt is provided by the business operator operating the work support system 1 is taken as an example, but the default prompt may be provided by any person. For example, the user may provide the default prompt, or another user in an organization to which the user belongs may provide the default prompt. The default prompt may be shared between users. The default prompt may be provided by another business operator cooperating with the business operator operating the work support system 1.

In the at least one embodiment, a case in which the data storage unit 200 stores the default prompt is taken as an example. For example, the default prompt acquisition module 203 refers to the data storage unit 200 to acquire the default prompt. The default prompt acquisition module 203 may acquire the default prompt from another computer other than the API request generation server 20 or an external information storage medium. The default prompt acquisition module 203 may acquire only one default prompt, or may acquire a plurality of default prompts. The default prompt acquisition module 203 may acquire a default prompt corresponding to the user input information among a plurality of default prompts.

For example, the AI may be capable of generating API requests for various APIs. Meanwhile, the work support system 1 may only support a specific API. In this case, the user may not designate the specific API. For that reason, text indicating that the AI is to generate an API request for a specific API may be provided as the default prompt. Such a default prompt enables the AI to identify for which API the API request is to be generated.

For example, the default prompt may be text indicating a role to be played by the AI, such as “You are an AI that supports the user in creating an API request.” Such a default prompt enables the AI to identify the role to be played by itself. For another example, the default prompt may be text indicating that the AI is to give some kind of answer to the user together with the API request, such as “Please explain the API request you have generated.” Such a default prompt enables the AI to identify that the AI is to generate an answer (for example, an explanation of the API request) to the user together with code such as the API request. For example, the default prompt may be text indicating what kind of information each of the user input information, the API specification information, the function setting information, the template request is.

### [API Request Generation Module]

The API request generation module 204 executes the API request generation processing. The API request generation processing is processing for generating an API request. The API request generation module 204 generates an API request for the transmission destination API among a plurality of APIs relating to the support of the work based on the user input information and the AI. For example, the API request generation module 204 inputs the input data including the user input information to the AI. In the at least one embodiment, the AI is stored in an external system, and hence the API request generation module 204 transmits the input data to the external system. When the AI is stored in the data storage unit 200, the API request generation module 204 is only required to input the input data to the AI stored in the data storage unit 200.

For example, the AI calculates the embedded representation of the input data based on parameters adjusted by previously performed training. In the at least one embodiment, a case in which a large language model exemplified by GPT corresponds to the AI is taken as an example, and hence the AI divides the input data into tokens and calculates the embedded representations of the individual tokens based on the parameters. The AI predicts a continuation based on the sequential order of the embedded representations of the tokens as required. The AI outputs the API request as the output data based on the sequential order. The AI may output the output data including not only the code of the API request but also at least one of code such as a script that meets the user input information or text of an answer to the user. The API request generation module 204 generates code that meets the user input information by acquiring the API request included in the output data output by the AI.

For example, the user input information is acquired based on the input of the user, and hence the content relating to the processing that the user wishes to execute through use of the API is indicated in the user input information. In the examples of FIG. 2 and FIG. 3, the user input information indicates the extension content of the work support function that the user wishes. For example, the user input information indicates such specific content as to turn the record with the oldest meeting date green. The AI can understand such user input information by language analysis and generate, together with code for the extension of the work support function to be extended, an API request for the execution of the code. The AI generating the API request in the work support system 1 is a novel configuration at the time of filing, but a technology publicly known at the time of filing may be used as a technology itself for the AI to generate code such as the API request based on a prompt. Thus, a person skilled in the art can understand the processing in which the AI generates the API request in the at least one embodiment to a degree that the processing can be implemented based on the description of the at least one embodiment and the common general technical knowledge at the time of filing.

In the at least one embodiment, the API request generation module 204 generates the API request further based on the API specification information. For example, the API request generation module 204 inputs the input data including the user input information and the API specification information to the AI. The AI calculates the embedded representation based on not only the user input information but also the API specification information. The embedded representation reflects not only the user input information but also the API specification indicated by the API specification information. The AI outputs the output data including code corresponding to the calculated embedded representation. The API request generation module 204 acquires the code included in the output data output by the AI, to thereby generate the API request corresponding to the API specification information.

For example, the AI roughly identifies what kind of specification the API request is to have based on the embedded representation corresponding to the API specification that meets the API specification information. The AI generates an API request that meets the API specification information based on the roughly identified specification. In the examples of FIG. 2 and FIG. 3, the code for the extension of the function of the app, which is an example of the work support function, is generated, and hence the API specification information indicates the specification of the code execution API. The AI identifies the specification of the code execution API based on the API specification information, and generates output data including an API request that satisfies the specification.

In the example of FIG. 6, the input data including not only the user input information and the API specification information but also the function setting information, the template request, and the default prompt is input to the AI. Thus, the API request generation module 204 acquires each of the function setting information, the template request, and the default prompt.

The API request generation module 204 acquires function setting information relating to a setting of the work support function. The function setting information indicates the setting of the work support function to be extended. In the examples of FIG. 2 and FIG. 3, the database function of the app selected by the user corresponds to the work support function to be extended. The app selected by the user is the app (in the examples of FIG. 2 and FIG. 3, “meeting minutes management app”) displayed on the work support screen SC when the user input information is acquired. Thus, the function setting information indicates the setting of the app selected by the user. The API request generation module 204 may acquire only one piece of function setting information, or may acquire a plurality of pieces of function setting information.

In the at least one embodiment, the setting data on the app selected by the user is stored in a work support database DB2 described later, and hence the API request generation module 204 acquires, as the function setting information, at least one item in the setting data stored in the work support database DB2. The API request generation module 204 may acquire all items in the setting data as the function setting information, but in the at least one embodiment, the API request generation module 204 acquires field setting items of the app selected by the user in the setting data as the function setting information. It is assumed that the API request generation module 204 does not acquire other items in the setting data, such as an access right setting, as the function setting information.

In the examples of FIG. 2 and FIG. 3, the meeting minutes management app selected by the user has seven fields including “Record Number,” “Meeting Date,” “Meeting Time,” “Attendees,” “Agenda,” “Decision,” and “Next Step.” The API request generation module 204 acquires the function setting information including field codes, field names, field types, and a sequential order of those seven fields or a combination of those of the seven fields. When other setting items are present as the field setting items, the API request generation module 204 may acquire the function setting information including the other setting items.

The function setting information is only required to indicate a setting corresponding to the work support function to be extended. The function setting information is not limited to the example in the at least one embodiment. For example, the function setting information may indicate another setting other than the field setting of the app. The function setting information may indicate an app name, a note for an administrator who manages the app, a layout of a form for the user to input data, a display format of the list L, a format of a graph to be displayed based on data stored in the app, an icon of the app, another design of the app, a notification setting, an access right setting, or another setting.

In the at least one embodiment, the API request generation module 204 generates the API request further based on the function setting information. For example, the API request generation module 204 inputs the input data including the user input information and the function setting information to the AI. The AI calculates the embedded representation based on not only the user input information but also the function setting information. The embedded representation reflects not only the user input information but also the setting indicated by the function setting information. The AI outputs the output data including the API request corresponding to the calculated embedded representation. The API request generation module 204 acquires the API request included in the output data output by the AI, to thereby generate the API request corresponding to the function setting information.

For example, the API request generation module 204 generates a template request relating to the work support function, the template request being provided in advance. The template request is an API request provided in advance. The template request may include code that serves as a template (for example, an API request that serves as a template). In the at least one embodiment, a case in which a business operator operating the work support system 1 provides the template request is taken as an example, but the template request may be provided by any person. For example, the user may provide the template request. The template request may be shared between users. The template request may be provided by another business operator cooperating with the business operator operating the work support system 1.

For example, the data storage unit 200 stores a template database in which template requests are stored. In the template database, an index for searching for a template request through use of the user input information as a query may be associated with the template request. The API request generation module 204 generates a template request from the template database. The API request generation module 204 may generate the template request from another database other than the API specification information database DB1, another computer other than the API request generation server 20, or an external information storage medium. The API request generation module 204 may acquire only one template request, or may generate a plurality of template requests.

In the at least one embodiment, the API request generation module 204 generates the API request further based on the template request. For example, the API request generation module 204 inputs the input data including the user input information and the template request to the AI. The AI calculates the embedded representation based on not only the user input information but also the template request. The embedded representation reflects not only the user input information but also a feature of the template request. The AI outputs the output data including the API request corresponding to the calculated embedded representation. The API request generation module 204 acquires the API request included in the output data output by the AI, to thereby generate the API request corresponding to the template request.

In the at least one embodiment, the API request generation module 204 generates the API request further based on the default prompt. For example, the API request generation module 204 inputs the input data including the user input information and the default prompt to the AI. The AI calculates the embedded representation based on not only the user input information but also the default prompt. The embedded representation reflects not only the user input information but also the setting indicated by the default prompt. The AI outputs the output data including the API request corresponding to the calculated embedded representation. The API request generation module 204 acquires the API request included in the output data output by the AI, to thereby generate the API request corresponding to the default prompt. For example, when the transmission destination API of the API request to be generated by the AI is indicated in the default prompt, the AI identifies, for the API request generation module 204, for which API the API request is to be generated based on the embedded representation corresponding to the default prompt.

The API request generation module 204 may generate the API request based on the input data including other information. For example, the API request generation module 204 may generate the API request based on the input data including not only the function setting information on the app selected by the user but also data stored in a record of the app.

### [API Request Transmission Module]

The API request transmission module 205 transmits the API request to the transmission destination API. That is, the API request transmission module 205 transmits the API request to the API endpoint (for example, the work support server 30) of the transmission destination API. Information that can identify the transmission destination API (that is, information that can identify the API endpoint of the transmission destination API) is assumed to be stored in advance in the data storage unit 200. The API request transmission module 205 may identify where to transmit the API request based on the information.

In the at least one embodiment, the transmission destination API is selected by the API specification information acquisition module 202, and hence the API request transmission module 205 transmits the API request generated by the API request generation module 204 to the transmission destination API selected by the API specification information acquisition module 202. The transmission destination API may be selected by another function other than the API specification information acquisition module 202. In this case, the API request transmission module 205 may transmit the API request generated by the API request generation module 204 to the transmission destination API selected by the AI.

For example, the transmission destination API may be selected by the AI. In this case, the API request transmission module 205 may transmit the API request generated by the API request generation module 204 to the transmission destination API selected by the AI. The transmission destination API may be selected by the user. In this case, the API request transmission module 205 may transmit the API request generated by the API request generation module 204 to the transmission destination API selected by the user.

### 3-3. Functions Implemented in Work Support Server

For example, the work support server 30 includes a data storage unit 300 and a work support module 301. The data storage unit 300 is implemented by the storage unit 32. The work support module 301 is implemented by the control unit 31.

### [Data Storage Unit]

The data storage unit 300 stores data required for the work support processing. For example, the data storage unit 300 stores the work support database DB2 in which various kinds of data on the work support system 1 are stored. In the at least one embodiment, a scene in which the user extends the function of the app is taken as an example, and hence a case in which various kinds of data on the app are stored in the work support database DB2 is taken as an example.

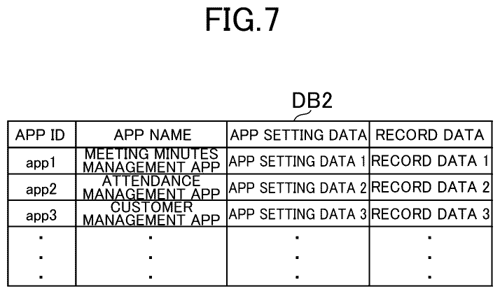

FIG. 7 is a table for showing an example of the work support database DB2. For example, the work support database DB2 stores an app ID, an app name, app setting data, and record data. The data stored in the work support database DB2 is not limited to the example of FIG. 7. For example, the work support database DB2 may store other data (for example, data on conversation threading in which users communicate with each other, data on schedules, or data on emails) other than the app.

The app ID is an ID that can identify the app. The app name is a name of the app. The app setting data indicates the setting of the app designated by the user with no-code or low-code. For example, the app setting data may be the above-mentioned field setting, a graph setting, a display setting of the list L, an access right setting, or another setting. The code generated by the AI may be saved as part of the app setting data. The record data is data stored in a record. When the user creates a new app, data such as the app ID of the new app is stored in the work support database DB2. When the user updates the app, the data on the app in the work support database DB2 is updated.

For example, the data storage unit 300 stores a program for the work support function and actual data of each of the plurality of APIs. The actual data of each API includes: a program for performing various kinds of processing such as acquisition or transmission of data; and data including settings to be referred to by the program. The program for the work support function can also be called up through the processing of the program included in the actual data of the API. The actual data of the API may be similar to data employed in a publicly-known API. The data storage unit 300 may store data (for example, information that can identify the API endpoint of each of the plurality of APIs) required for the work support server 30 to receive the API request.

The data stored in the data storage unit 300 is not limited to the above-mentioned example. It suffices that the data storage unit 300 stores data required for supporting work. For example, the data storage unit 300 may store data (for example, HTML data or image data) required for displaying the work support screen SC, or may store data (for example, a deployment program) required for deploying the code. The data storage unit 300 may store the API specification information on each of the plurality of APIs.

### [Work Support Module]

The work support module 301 executes the work support processing for supporting work of users. The work support processing is processing for providing the work support function to the user. For example, the work support processing is processing for displaying the work support screen SC on the user terminal 40. In the at least one embodiment, the API request generated by the API request generation server 20 is transmitted to the transmission destination API, and hence the work support module 301 executes the processing requested by the API request transmitted to the transmission destination API. For example, the work support module 301 executes the processing requested by the API request based on the program included in the actual data of the transmission destination API stored in the data storage unit 300.

The processing for executing the API request transmitted to the transmission destination API may be the same as processing employed in a publicly-known API. The work support module 301 transmits an execution result of the API request to the user terminal 40 directly or indirectly (for example, through at least one of the voice conversion server 10 or the API request generation server 20). In the examples of FIG. 2 and FIG. 3, the work support module 301 executes the API request received by the code execution API to deploy code for implementing the extension of the function desired by the user. The deployment is deployment to the work support function to be extended. In the examples of FIG. 2 and FIG. 3, the deployment is deployment of the code to the app selected by the user. The work support module 301 deploys the code by embedding the code in the display data (e.g., HTML data) on the work support screen SC. The code may be embedded at any location in the display data.

For example, the work support module 301 provides the code to the user by executing processing for displaying a screen indicating a deployment result of the code on the user terminal 40 of the user. The work support screen SC in the lower half of FIG. 3 is an example of the screen indicating the deployment result of the code. Thus, the work support screen SC in the lower half of FIG. 3 as described herein can be read as the screen indicating the deployment result of the code. The screen indicating the deployment result of the code is only required to be a screen of the work support function to be extended. The method itself for the deployment may be a publicly-known method. For example, the work support server 30 may execute the code and transmit only the data indicating the execution result thereof to the user terminal 40.

For example, when the user confirms that the extension of the function that meets his or her own wish has been performed, the user performs the operation for ending the generation of the API request. In this case, the work support server 30 stores the code generated by the API request in the data storage unit 300 in association with the user. The user can use the code stored in the data storage unit 300 from the next time onward. For example, when the user calls up again the app for which the code has been generated by the AI, the display data on the work support screen SC of the app already includes the code. The user can also correct or delete the code stored in the data storage unit 300.

### 3-4. Functions Implemented in User Terminal

For example, the user terminal 40 includes a data storage unit 400, a display control module 401, and an operation reception module 402. The data storage unit 400 is implemented by the storage unit 42. Each of the display control module 401 and the operation reception module 402 is implemented by the control unit 41.

### [Data Storage Unit]

The data storage unit 400 stores data for the work support. For example, the data storage unit 400 stores a browser for displaying various screens of the work support system 1. For example, the data storage unit 400 stores an application dedicated to the work support system 1. The data storage unit 400 stores the display data on the work support screen SC.

### [Display Control Module]

The display control module 401 displays various screens in the work support system 1 on the display unit 45. For example, the display control module 401 displays the work support screen SC on the display unit 45 based on data received from the voice conversion server 10, the API request generation server 20, or the work support server 30.

### [Operation Reception Module]

The operation reception module 402 receives various operations in the work support system 1. For example, the operation reception module 402 receives operations on the work support screen SC. Data indicating the operation content received by the operation reception module 402 is transmitted to the voice conversion server 10, the API request generation server 20, or the work support server 30 as appropriate.

### 4. Processing Executed in Work Support System

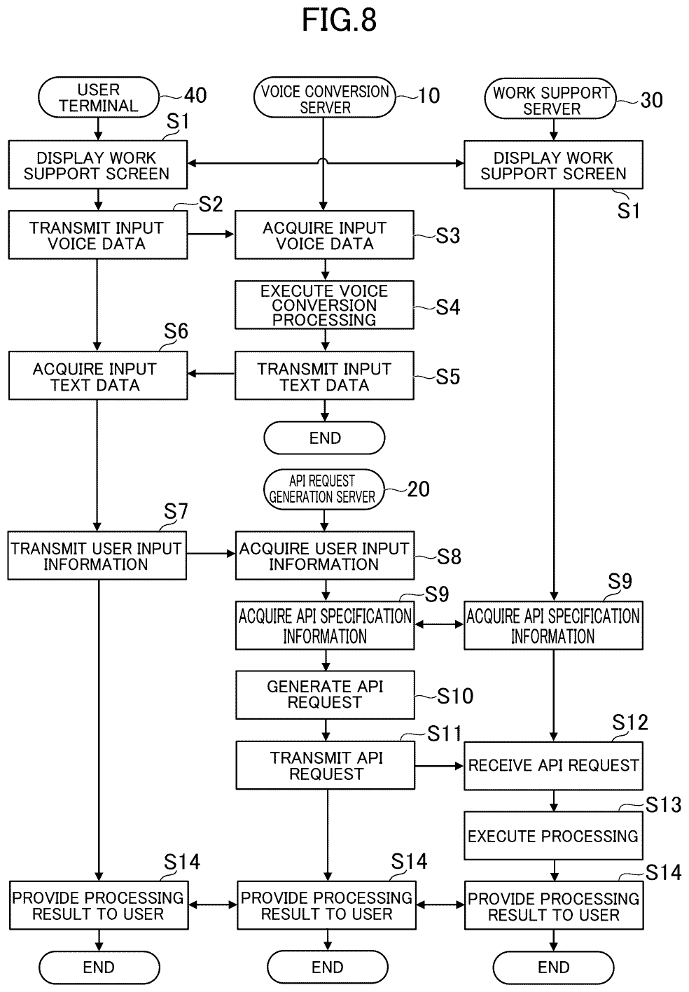

FIG. 8 is a flowchart for illustrating an example of processing executed in the work support system 1. The processing of FIG. 8 is executed by the control units 11, 21, 31, and 41 executing the programs stored in the storage units 12, 22, 32, and 42, respectively. Respective processing steps of FIG. 8 are examples of processing steps included in the work support method. In FIG. 8, an example of processing performed so as to extend the work support function of the app is illustrated. In FIG. 8, the user terminal 40 may communicate indirectly to/from each of the voice conversion server 10 and the API request generation server 20 through the work support server 30 instead of directly communicating to/from each thereof.

As illustrated in FIG. 8, the user terminal 40 executes, between the user terminal 40 and the work support server 30, the processing for displaying the work support screen SC of the app selected by the user (Step S1). In Step S1, the work support server 30 generates display data on the work support screen SC of the app selected by the user based on the work support database DB2, and transmits the display data to the user terminal 40. When the user terminal 40 receives the display data on the work support screen SC, the user terminal 40 displays the work support screen SC on the display unit 45. After that, the user extends the work support function of the app in accordance with the flow of FIG. 2 and FIG. 3.

When the user terminal 40 receives input of voice from the user through the voice input unit 46, the user terminal 40 transmits the input voice data indicating the voice input by the user to the voice conversion server 10 (Step S2). The voice conversion server 10 acquires the input voice data from the user terminal 40 (Step S3). The voice conversion server 10 executes the voice conversion processing based on the voice conversion program and the input voice data (Step S4). The voice conversion server 10 transmits the input text data indicating the text of the voice input by the user (Step S5). The user terminal 40 acquires the input text data from the voice conversion server 10 (Step S6).

When the user selects the button B, the user terminal 40 transmits the user input information to the API request generation server 20 (Step S7). In Step S7, the user terminal 40 requests the API request generation server 20 to generate code of the API request or the like. In Step S7, the app ID of the app to be extended and information that can identify the currently displayed work support screen SC are also transmitted. The API request generation server 20 acquires the user input information and the like from the user terminal 40 (Step S8). The API request generation server 20 acquires the API specification information on the transmission destination API from the API specification information database DB1 (Step S9). The API request generation server 20 also executes processing for acquiring the function setting information, the template request, and the default prompt.

The API request generation server 20 generates an API request based on the AI and the input data including the user input information acquired in Step S8 and the API specification information acquired in Step S9 (Step S10). In Step S10, the API request generation server 20 transmits the input data to the external system managing the AI. The API request generation server 20 acquires the output data including the code of the API request or the like generated by the AI from the external system. The API request generation server 20 transmits the API request generated in Step S10 to the work support server 30 serving as the API endpoint for the transmission destination API (Step S11). The API request generated in Step S10 may be transmitted from the API request generation server 20 to the user terminal 40 and then transmitted to the work support server 30 by the user terminal 40.

The work support server 30 receives the API request from the API request generation server 20 (Step S12). The work support server 30 executes the processing requested by the API request (Step S13). In Step S13, the work support server 30 deploys the code such as a script generated by the AI. The work support server 30 cooperates with the API request generation server 20 and the user terminal 40 to execute the processing for providing the processing result of the API request to the user (Step S14), and the process ends. The work support server 30 transmits the display data on the work support screen SC to the user terminal 40. When the user terminal 40 receives the display data on the work support screen SC, the user terminal 40 executes the code included in the display data to display the work support screen SC on the display unit 45. When voice output of the answer from the AI is required, the voice conversion server 10 acquires data indicating the answer from the AI from the API request generation server 20, and executes the processing for converting text into voice. The converted voice is output by the user terminal 40.

### 5. Summary of at Least One Embodiment

The work support system 1 according to the at least one embodiment generates an API request for the transmission destination API among a plurality of APIs based on the user input information and the AI. The work support system 1 transmits the API request to the transmission destination API. This enables the user to have the API request executed by performing input for causing the work support system 1 to acquire the user input information even without coding the API request, and hence the work support system 1 can handle a plurality of APIs, thereby being able to increase the convenience of the user. For example, the user of the no-code or low-code work support system 1 may have no knowledge of APIs or may not have much knowledge of APIs. The user can easily extend the work support function by the API request generation processing of the work support system 1 even without acquiring knowledge of APIs. The user with knowledge of APIs does not require time and labor to code the API request, and hence the work support system 1 can increase the convenience of the user with knowledge of APIs.

Further, the work support system 1 generates the API request further based on the API specification information. This enables the work support system 1 to generate the API request that satisfies the specifications specific to the transmission destination API. For example, there is a possibility that a general-purpose AI may generate a general API request irrespective of the specifications specific to the transmission destination API. The AI can grasp the specifications specific to the transmission destination API based on the API specification information, and hence the work support system 1 more easily generates the API request that meets the wish of the user. For example, the work support system 1 can generate the API request that meets security specifications, thereby enabling reduction of security risks.

Further, the work support system 1 generates the API request further based on the default prompt. This enables the work support system 1 to generate the API request after supplementing an item missing in the input of the user with the default prompt. For example, even when the user does not input what kind of API request is to be generated by the AI, the work support system 1 defines a specific specification by the default prompt, to thereby be able to generate an API request having the specification.

### 6. Modification Examples

The present disclosure is not limited to the at least one embodiment described above. The present disclosure can be modified as required without departing from the purport of the present disclosure.

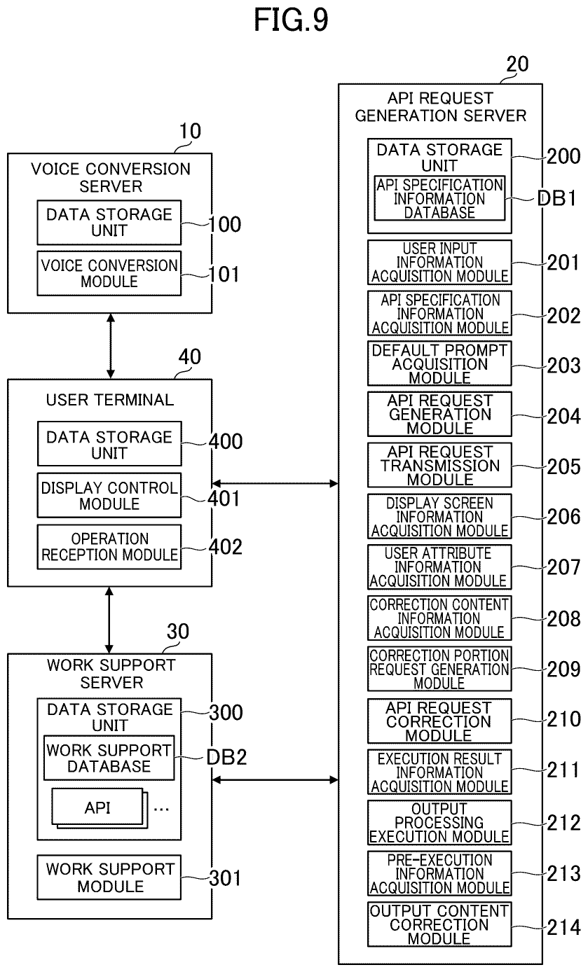

FIG. 9 is a diagram for illustrating an example of functions implemented in the work support system 1 according to modification examples. As illustrated in FIG. 9, in the modification examples described below, a display screen information acquisition module 206, a user attribute information acquisition module 207, a correction content information acquisition module 208, a correction portion request generation module 209, an API request correction module 210, an execution result information acquisition module 211, an output processing execution module 212, a pre-execution information acquisition module 213, and an output content correction module 214 are implemented. Each of the display screen information acquisition module 206, the user attribute information acquisition module 207, the correction content information acquisition module 208, the correction portion request generation module 209, the API request correction module 210, the execution result information acquisition module 211, the output processing execution module 212, the pre-execution information acquisition module 213, and the output content correction module 214 is implemented by the control unit 21.

### 6-1. Modification Example 1

For example, in the at least one embodiment, the case in which the API specification information acquisition module 202 acquires the API specification information based on the display screen information that can identify the work support screen SC displayed on the user terminal 40 has been taken as an example. The display screen information may be used for a purpose other than a purpose for causing the API specification information acquisition module 202 to acquire the API specification information. In Modification Example 1, a case in which the display screen information is used for another purpose is described.

The work support system 1 according to Modification Example 1 includes the display screen information acquisition module 206. The display screen information acquisition module 206 acquires the display screen information relating to the work support screen SC displayed on the user terminal 40 when the input of the user is performed. A method of acquiring the display screen information is as described in the at least one embodiment. The display screen information acquisition module 206 acquires the display screen information from the user terminal 40. For example, the display screen information may be included in a request such as an HTTP request transmitted from the user terminal 40. The URL of the work support screen SC or part thereof may be used as the display screen information.

The API request generation module 204 in Modification Example 1 generates an API request further based on the display screen information. For example, the API request generation module 204 may acquire the function setting information, which is described in the at least one embodiment, based on the display screen information. In the examples of FIG. 2 and FIG. 3, the display screen information may indicate the app ID that can identify the app. The API request generation module 204 may acquire the function setting information on the app indicated by the app ID based on the app ID indicated by the display screen information. The processing performed after the API request generation module 204 has acquired the function setting information is as described in the at least one embodiment.

For example, the API request generation module 204 may acquire specific content information indicating specific content indicated in the currently displayed work support system 1 instead of acquiring the API specification information based on the display screen information. In the examples of FIG. 2 and FIG. 3, the specific content information may indicate a specific value indicated in a field of the app, a file registered in a record, content of a comment exchanged in a record, or other information. The API request generation module 204 may input the input data including the specific content information to the AI. The AI calculates the embedded representation based on not only the user input information but also the specific content information. The embedded representation reflects not only the user input information but also a feature of the specific content information. The AI outputs the output data including the API request corresponding to the calculated embedded representation. The API request generation module 204 generates an API request corresponding to the specific content information by acquiring the API request included in the output data output by the AI.

The API request generation module 204 may input the input data including the display screen information to the AI instead of acquiring the function setting information based on the display screen information. Further, the display screen information may be a screenshot of the work support screen SC displayed on the user terminal 40. The screenshot is also an example of the information that can identify the work support screen SC displayed on the user terminal 40, and corresponds to at least information relating to the work support screen SC. The API request generation module 204 may input the input data including the display screen information, which is a screenshot, to the AI capable of image analysis. The AI calculates the embedded representation based on not only the user input information but also the screenshot. The embedded representation reflects not only the user input information but also a feature of the screenshot. The AI outputs the output data including the API request corresponding to the calculated embedded representation. The API request generation module 204 acquires the API request included in the output data output by the AI, to thereby generate an API request corresponding to the screenshot.

The work support system 1 according to Modification Example 1 generates the API request further based on the display screen information. This enables the work support system 1 to generate the API request corresponding to the work support screen SC displayed on the user terminal 40. For example, the work support system 1 can generate an API request specific to the setting relating to the work support screen SC. The work support system 1 can generate an API request specific to the value currently displayed on the work support screen SC. The work support system 1 can generate an API request specific to the screenshot of the work support screen SC.

### 6-2. Modification Example 2

For example, an appropriate API request may differ depending on the user. For that reason, in Modification Example 2, a case in which an API request corresponding to attributes of the user is generated is taken as an example. The work support system 1 according to Modification Example 2 includes the user attribute information acquisition module 207. The user attribute information acquisition module 207 acquires user attribute information relating to the attributes of the user. The user attribute information is information that enables classification of the user. Examples of the user attribute information may include the organization, organization size, department, job position, industry, profile, year of joining the company, age, gender, and other information of the user. The user attribute information may be information called demographic information.

In Modification Example 2, a case in which the data storage unit 300 of the work support server 30 stores a user database that stores the user attribute information is taken as an example. The user attribute information acquisition module 207 acquires the user attribute information from the user database. The user attribute information acquisition module 207 may acquire the user attribute information from another database other than the user database, another computer (for example, the API request generation server 20) other than the work support server 30, or an external information storage medium. The user may be able to edit his or her own user attribute information.

The API request generation module 204 in Modification Example 2 generates the API request further based on the user attribute information. For example, the API request generation module 204 inputs the input data including the user attribute information to the AI. The AI calculates the embedded representation based on not only the user input information but also the user attribute information. The embedded representation reflects not only the user input information but also the feature of the user attribute information. The AI outputs the output data including the API request corresponding to the calculated embedded representation. The API request generation module 204 acquires the API request included in the output data output by the AI, to thereby generate the API request corresponding to the user attribute information.

The work support system 1 according to Modification Example 2 generates the API request further based on the user attribute information. This enables the work support system 1 to generate the API request corresponding to the attributes of the user. For example, when an API request suitable for supporting the work of a user belonging to a large company and an API request suitable for supporting the work of a user belonging to a small-to-medium company are different from each other, the work support system 1 can generate the API request corresponding to the size of the organization to which the user belongs. When an API request suitable for supporting the work of a user who works in a food and beverage industry and an API request suitable for supporting the work of a user who works in an apparel industry are different from each other, the work support system 1 can generate the API request corresponding to the industry in which the user works.

### 6-3. Modification Example 3

For example, there may be a plurality of pieces of extension content with which to extend the work support function. In this case, the user may be able to successively specify pieces of extension content information with respect to the AI. In Modification Example 3, a case in which a function of turning a record with the most recent meeting date red and a function of duplicating a record including a specific user in the attendees are added to the app after the function of turning the record with the oldest meeting date green is added to the app as in FIG. 2 and FIG. 3 is taken as an example. The user is to perform the input three times in total.

The user input information acquisition module 201 in Modification Example 3 acquires the user input information each time the user performs new input. For example, under the state of the work support screen SC in the lower half of FIG. 3, the user performs voice input indicating that the record with the most recent meeting date is to be turned red. The AI generates an API request for turning the record with the most recent meeting date red based on the user input information corresponding to the voice input by the user. After that, the user performs voice input indicating that the record including the specific user in the attendees is to be duplicated. The AI generates an API request for duplicating the record including the specific user in the attendees based on the user input information corresponding to the voice input by the user. In this manner, the user input information acquisition module 201 acquires the user input information each time the user successively performs input.

The API request generation module 204 in Modification Example 3 generates the API request further based on a history of the user input information. The history includes at least one piece of user input information. The history of the user input information is assumed to be stored in the data storage unit 200. The API request generation module 204 acquires the history of the user input information stored in the data storage unit 200, and generates code such as the API request. The API request generation module 204 may acquire the history of the user input information from another computer such as the user terminal 40. At a time of the first input performed by the user, there is no history of the user input information, and hence the API request generation module 204 generates the API request based on a piece of user input information at the time of the first input. This processing is as described in the at least one embodiment. At a time of the second input or the subsequent input performed by the user, the API request generation module 204 generates the API request further based on the history of the user input information.

For example, the API request generation module 204 inputs, to the AI, the input data including a new piece of user input information and the history of the user input information. The AI calculates the embedded representation based on not only the new piece of user input information but also the history of the user input information. The embedded representation reflects not only the new piece of user input information but also the feature of the history of the user input information. The AI outputs the output data including the API request corresponding to the calculated embedded representation. The API request generation module 204 acquires the API request included in the output data output by the AI, to thereby generate the API request corresponding to the history of the user input information.

The work support system 1 according to Modification Example 3 generates the API request further based on the history of the user input information. This enables the work support system 1 to generate the API request that takes into consideration not only the most recent input performed by the user but also the input performed in the past by the user, thereby being able to increase the convenience of the user. For example, while the user repeatedly performs input, the user may omit information that was previously input. The use of the history of the user input information enables the work support system 1 to identify the information omitted by the user from the previous context and generate the API request.

### 6-4. Modification Example 4

For example, the API request generation module 204 may generate an API request by supplementing a provisional API request output by the AI with supplement information relating to the support of the work. The provisional API request is the output itself from the AI. The supplement information is information to be added to the provisional API request. For example, the supplement information may be the display screen information, the function setting information, the specific content information, or other information. A method of acquiring those pieces of information is as described above. The supplement information may be information provided in advance on the API request generation server 20 side. The supplement information may be stored in the data storage unit 200.

For example, the API request generation module 204 generates an API request to be transmitted to the transmission destination API by embedding all or part of those kinds of supplement information in the provisional API request. A location at which the supplement information is embedded is assumed to be defined in advance. For example, the API request generation module 204 may embed all or part of the supplement information at the beginning or end of the provisional API, in a portion written in a markup language such as JSON, or in another portion. The API request transmission module 205 transmits, to the transmission destination API, the API request in which all or part of the supplement information is embedded in the provisional API request.

The work support system 1 according to Modification Example 4 generates the API request by supplementing the provisional API request output by the AI with the supplementary information. This enables the work support system 1 to supplement missing information output by the AI with the supplementary information, and thus generate a more appropriate API request.

### 6-5. Modification Example 5

For example, the AI may not be able to generate an API request that meets the wish of the users at once. For that reason, the user may be able to give an instruction to correct the API request generated by the AI. In the examples of FIG. 2 and FIG. 3, the user may give an instruction to correct the API request generated by the AI from the work support screen SC in the lower half of FIG. 3. In Modification Example 5, a case in which the user gives an instruction to correct the API request by voice input is taken as an example, but the user may give an instruction to correct the API request by any other input method. For example, the user may give an instruction to correct the API request by text input.

The user may explicitly instruct the work support system 1 to correct the API request by voice input, text input, or another operation (for example, by selecting a “Correct” button). The work support system 1 can identify, based on the explicit instruction from the user, that the generated API request is to be corrected rather than a new API request is to be generated. Even when the user does not give an explicit instruction, the AI may infer that the API request is to be corrected. The AI may identify, based on the input data, that the generated API request is to be corrected rather than a new API request is to be generated. The AI can perform such identification through use of the embedded representation of the input data.

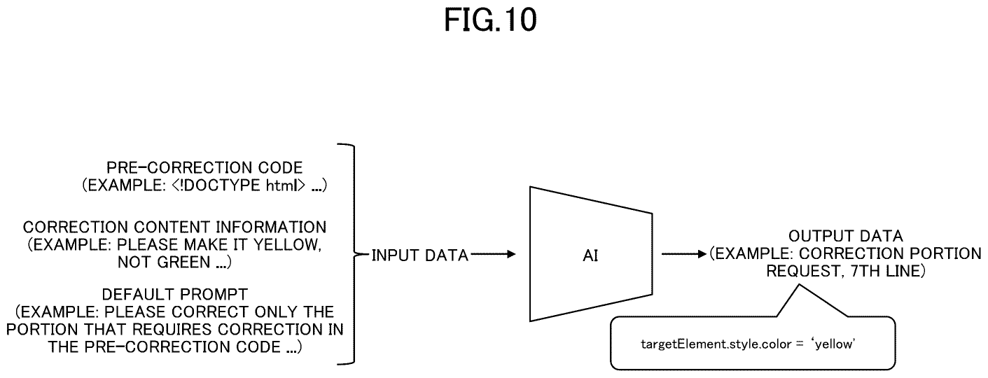

FIG. 10 is a diagram for illustrating an example of processing for the correction of the API request. The work support system 1 according to Modification Example 5 includes the correction content information acquisition module 208, the correction portion request generation module 209, and the API request correction module 210. The correction content information acquisition module 208 acquires correction content information relating to correction content of the API request based on the input of the user. The correction content information is an instruction indicated by the input of the user at a time of the correction of the API request. The correction content information can also be said to be the intention of the user at the time of the correction. The correction content information may also be called a prompt for the AI. As in FIG. 10, at the time of the correction, the input data including the correction content information is input to the AI.

In Modification Example 5, a case in which text input in the input form F when the user selects the button B at the time of the correction of the API request corresponds to the correction content information is taken as an example. Thus, the correction content information is text indicating specific content with which the user wishes to correct the API request. When the user selects the button B, the user terminal 40 transmits the correction content information, which is the text input in the input form F, to the API request generation server 20. The correction content information acquisition module 208 acquires the correction content information from the user terminal 40. The correction content information acquisition module 208 may acquire only one piece of correction content information, or may acquire a plurality of pieces of correction content information.

The correction content information may not be text in a natural language but may be the voice itself that has been used in the input by the user. In this case, the correction content information acquisition module 208 may acquire the correction content information, which is the voice, from the user terminal 40 and then request the voice conversion server 10 to convert the correction content information into text. The correction content information acquisition module 208 acquires the correction content information converted into text from the voice conversion server 10. The correction content information acquisition module 208 may acquire the correction content information indirectly through the voice conversion server 10, the work support server 30, or another computer, instead of acquiring the correction content information directly from the user terminal 40.

The correction portion request generation module 209 generates a correction portion request, which is a post-correction request of a correction portion corresponding to the correction content in the pre-correction API request, based on the correction content information and the AI. The correction portion corresponding to the correction content is a portion in the pre-correction API request. An amount of the correction portion varies depending on the correction content. For example, the correction portion may be only one line, or may be two or more lines. The correction portion may not be a certain set of consecutive lines. For example, the third and 10th lines of a 20-line API request may be the correction portions. Which portion is to be corrected is determined by the AI.

For example, the AI outputs, together with the correction portion request, correction portion identification information that can identify the correction portion in the pre-correction API request. The correction portion identification information can also be said to be a location of the correction portion in the pre-correction API request. For example, the correction portion identification information indicates which line the correction portion is on. As the default prompt at the time of the correction, a prompt such as “Please correct only the portion that requires correction in the pre-correction API request. Please output the post-correction correction portion request of that portion and the identification information on that portion.” may be provided. Such a default prompt enables the AI to more accurately understand that it is only required to output the correction portion request and the correction portion identification information.

For example, the correction portion request generation module 209 inputs the input data including the pre-correction API request and the correction content information to the AI. In the example of FIG. 10, the correction portion request generation module 209 inputs the input data further including the default prompt to the AI. The AI calculates the embedded representation based on not only the correction content information but also the pre-correction API request. The embedded representation reflects not only the correction content information but also the pre-correction API request. The AI outputs the output data including the correction portion request and the correction portion identification information corresponding to the calculated embedded representation. The correction portion request generation module 209 acquires the correction portion request and the correction portion identification information included in the output data output by the AI. In the example of FIG. 10, only the 7th line of the pre-correction API request is output from the AI as the API request. The correction portion identification information indicates that the correction portion is on the 7th line.

The API request correction module 210 corrects the API request by replacing the correction portion in the pre-correction API request by the correction portion request. The replacement can also be said to be overwriting or change. In the example of FIG. 10, the 7th line of the pre-correction API request is replaced by the correction portion request. For example, the API request correction module 210 replaces the correction portion indicated by the correction portion identification information in the pre-correction API request by the correction portion request. The user may designate the correction portion. For example, the user may perform input such as “Please correct the 7th line.” In this case, the correction content information includes the correction portion identification information. The AI may not output the correction portion identification information. Even when the AI does not output the correction portion identification information, the API request correction module 210 is only required to replace the correction portion input by the user by the correction portion request.

The API request transmission module 205 in Modification Example 5 transmits, to the transmission destination API, the API request corrected by the API request correction module 210. The API request transmission module 205 in Modification Example 5 differs in that the API request transmission module 205 transmits, to the transmission destination API, the API request corrected by the API request correction module 210 in place of the API request newly generated by the API request generation module 204, but a method itself of transmitting the API request may be the same as in the at least one embodiment.

The work support system 1 according to Modification Example 5 acquires the correction content information based on the input of the user. The work support system 1 generates a correction portion request based on the correction content information and the AI. The work support system 1 corrects the API request by replacing the correction portion in the pre-correction API request by the correction portion request. The work support system 1 transmits the corrected API request to the transmission destination API. This enables the work support system 1 to increase the efficiency of a correction task for the API request performed by the user, thereby increasing the convenience of the user at the time of the correction. For example, when the AI regenerates the entire API request, there is a possibility that an API request indicating completely different processing from before the correction may be generated, but the work support system 1 replaces only the correction portion in the pre-correction API request by the correction portion request, thereby preventing the processing from becoming completely different from before the correction, for example, and increasing accuracy of the correction.

### 6-6. Modification Example 6

For example, in the work support system 1, terms specific to the work of users may be used. In view of this, the voice conversion module 101 may convert the voice of the user into text based on term information relating to terms specific to the work support system 1. The term information is a dictionary that stores terms specific to the work of users. The term information may be provided for each of industries of users. For example, for each of a medical care industry, a marketing industry, a food and beverage industry, and another industry, the term information indicating terms specific to each of those industries may be provided. The term information may be provided by an administrator of the work support system 1, or may be provided by the user or another person.

In Modification Example 6, it is assumed that the data storage unit 100 stores the term information. The voice conversion module 101 acquires the term information from the data storage unit 100. The voice conversion module 101 may acquire the term information from another computer other than the voice conversion server 10 or an external information storage medium. For example, it is assumed that the term information indicates the terms specific to the work of users and a voice pattern (a pattern of a voice waveform) of each of the terms. The voice conversion module 101 converts the voice input by the user into text based on the input voice data acquired from the user terminal 40, the voice conversion program, and the term information. For example, the voice conversion program refers to the term information to determine whether or not a term indicated in the term information has been spoken based on the voice pattern indicated by the input voice data and the voice pattern indicated in the term information. The voice conversion program converts the voice indicated by the input voice data into text based on a result of the determination.

The user input information acquisition module 201 in Modification Example 6 acquires the user input information indicating the text converted by the voice conversion module 101. Modification Example 6 differs from the at least one embodiment in that the term information is used in the voice conversion executed in order to acquire the user input information, but a method by which the user input information acquisition module 201 acquires the user input information obtained by converting the voice into text may be the same as that in the at least one embodiment. The user input information acquisition module 201 acquires, from the voice conversion server 10, the user input information obtained by converting the voice into text.

The work support system 1 according to Modification Example 6 converts the voice of the user into text based on the term information. This enables the work support system 1 to achieve the voice conversion based on the terms specific to the work support system 1, thereby being able to increase accuracy of the voice conversion. As a result, the user is no longer required to correct the text, and hence the work support system 1 can further increase the convenience of the user.

### 6-7. Modification Example 7

For example, the API request generation module 204 may be capable of generating an API request in which each of APIs of each of a plurality of work support systems 1 including the work support system 1 is set as the transmission destination API. In Modification Example 7, there are other work support systems 1 in addition to the work support system 1 illustrated in FIG. 1. Business operators operating the respective plurality of work support systems 1 may be the same as each other, or may be different from each other. Each of the plurality of work support systems 1 includes the same configuration as that of the work support server 30, and has at least one API.

For example, the API specification information database DB1 stores the API specification information on the APIs of the plurality of work support systems 1. The acquisition target data described in the at least one embodiment indicates a relationship between the work support screen SC of each of the plurality of work support systems 1 and the API specification information on the API of the each of the plurality of work support systems 1. The display screen information acquired from the user terminal 40 indicates the work support screen SC of a certain work support system 1. The API specification information acquisition module 202 acquires the API specification information on the API of the certain work support system 1 associated with the work support screen SC of the certain work support system 1 based on the acquisition target data. The API request generation module 204 generates an API request based on the API specification information on the API of the certain work support system 1.

Even when the API specification information is not used in generation of an API request, the API request generation module 204 can generate an API request by setting each of the APIs of each of the plurality of work support systems 1 as the transmission destination API. For example, the API request generation server 20 may acquire system-in-use information that can identify the work support system 1 being used by the user among the plurality of work support systems 1. The API request generation module 204 may input the input data including the system-in-use information to the AI and acquire the API request output from the AI.

The work support system 1 according to Modification Example 7 can generate the API request in which each of the APIs of each of the plurality of work support systems 1 as the transmission destination API. This enables the work support system 1 to generate an API request capable of handling the APIs of various work support systems 1, thereby increasing the convenience of the user. For example, the work support system 1 can generate an API request capable of handling various systems without depending on a specific system.

### 6-8. Modification Example 8

For example, in the at least one embodiment, the case in which the AI generates an answer to the user based on the user input information has been taken as an example. A method of generating an answer to the user from the AI is not limited to the example in the at least one embodiment. The API request generated by the API request generation module 204 may be successful or fail depending on the processing of the transmission destination API. For that reason, it may be suitable to output an answer based on the execution result of the API request to the user. In view of this, in Modification Example 8, a case in which the AI generates an answer to the user based on the execution result of the API request is taken as an example.

The work support system 1 according to Modification Example 8 includes the execution result information acquisition module 211 and the output processing execution module 212. The execution result information acquisition module 211 acquires execution result information relating to the execution result of the API request. The execution result information is information indicating whether or not the processing requested by the API request has been successful. For example, the execution result information indicates a first value indicating that the processing requested by the API request has been successful or a second value indicating that the processing requested by the API request has failed. The execution result information may be other information other than the success or failure of the processing requested by the API request. For example, the execution result information may include an error code indicating a cause of the failure. The execution result information can also be said to be information indicating a status relating to the API request. For example, the execution result information may be information called a status code included in an API response that is a response to the API request. That is, the execution result information may be included in the API response. A format of the API response may be a publicly-known format.

For example, when the work support server 30 executes the processing requested by the API request based on the transmission destination API, the work support server 30 generates execution result information based on the execution result of the processing. A method of generating execution result information may be the same as a publicly-known method of generating an API response. A program required for generating execution result information is assumed to be stored in the data storage unit 300. The work support server 30 transmits the execution result information to the API request generation server 20. The execution result information acquisition module 211 acquires the execution result information from the work support server 30. The work support server 30 may transmit the execution result information to another computer (for example, the user terminal 40) other than the API request generation server 20. Processing for generating execution result information may be indicated in a program indicating the processing requested by the API request, or may be indicated in another program. Each of those programs may be part of the transmission destination API, or may be a program different from the transmission destination API. Those programs are assumed to be stored in the data storage unit 300.

In Modification Example 8, the work support server 30 determines whether or not the processing requested by the API request has been successful. When the work support server 30 determines that the processing requested by the API request has been successful, the work support server 30 generates execution result information indicating the first value. When the work support server 30 determines that the processing requested by the API request has failed, the work support server 30 generates execution result information indicating the second value. When the execution result information indicates another value other than the success or failure of the processing, the work support server 30 may generate execution result information indicating the other value based on the execution result of the processing. Processing result data indicating a relationship between the execution result of the processing and the value indicated by the execution result information is assumed to be stored in advance in the data storage unit 300. It suffices that the work support server 30 identifies, based on the processing result data and the execution result of actual processing, the value to be indicated by the execution result information and generate execution result information indicating the value.

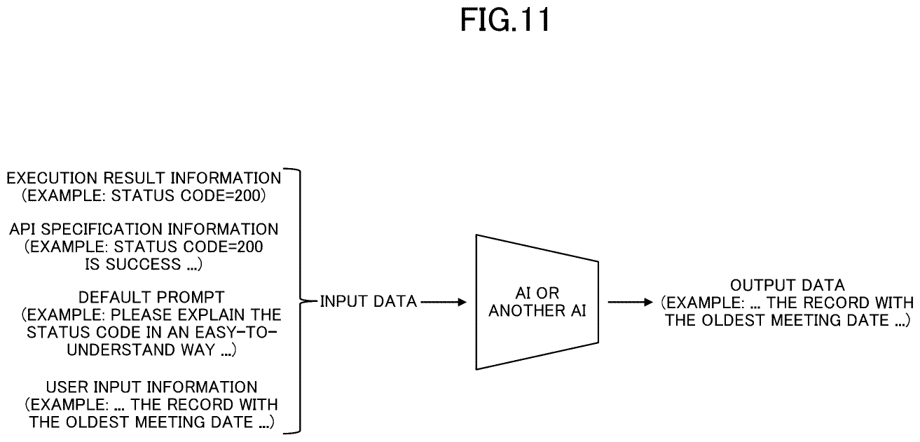

FIG. 11 is a diagram for illustrating an example of processing in which the answer to the user is output in Modification Example 8. In Modification Example 8, an AI different from the AI used in the generation of an API request is referred to as “another AI.” Another AI may be any model such as a large language model in the same manner as the AI used in the generation of an API request. Another AI may be a model of each method described in the example of the AI used in the generation of an API request. Another AI may be present outside the work support system 1, or may be present inside the work support system 1. The AI that has been used in the generation of an API request is hereinafter referred to simply as “the AI.” For example, the output processing execution module 212 executes output processing relating to output to the user based on the execution result information and the AI or another AI.

For example, the output processing execution module 212 inputs the input data including the execution result information to the AI or another AI. The AI or another AI calculates an embedded representation based on the input data. A method of calculating the embedded representation may be the same as that of calculation performed at the time of generating an API request, which has been described in the at least one embodiment. The AI or another AI may calculate an embedded representation indicating a feature of the input data based on its own parameters. The AI or another AI outputs the output data including the answer corresponding to the calculated embedded representation.

In the example of FIG. 11, the execution result information indicates the first value meaning that the processing requested by the API request has been successful. Thus, the AI or another AI recognizes that the processing requested by the API request has been successful by the embedded representation calculated based on the input data including the execution result information indicating the first value, and outputs the output data including the answer indicating that the processing has been successful (in the example in the lower half of FIG. 3, an answer such as “I have created a function of turning the record with the oldest meeting date green”).

For example, when the execution result information indicates the second value meaning that the processing requested by the API request has failed, the AI or another AI may recognize that the processing requested by the API request has failed by the embedded representation calculated based on the input data including the execution result information indicating the second value, and output the output data including the answer indicating that the processing has failed.

For example, the output processing execution module 212 executes the output processing for displaying the answer indicated by the output data on the user terminal 40. In the example in the lower half of FIG. 3, the output processing execution module 212 transmits the data indicating the answer indicated by the output data to the user terminal 40. The user terminal 40 updates the display of the display region A based on the data, and displays the answer in the display region A. The answer may be converted into voice by the voice conversion server 10 and then output.

The meaning of the value indicated by the execution result information may differ depending on the API. For that reason, the output processing execution module 212 may execute the output processing further based on the API specification information. It is assumed that the value indicated by the execution result information is defined in the API specification information. For example, the API specification information may define that the execution result information indicating a certain value means the success of the processing, and the execution result information indicating another value means the failure of the processing. For example, the output processing execution module 212 inputs the input data including the API specification information to the AI or another AI. The AI or another AI outputs the output data including the answer corresponding to the embedded representation calculated based on the input data including the API specification information.

The output processing execution module 212 may also execute the output processing further based on the default prompt. For example, a default prompt such as “The execution result of the processing requested by the API request is ∘∘. Please generate an answer to the user based on the execution result.” may be stored in the data storage unit 200. The output processing execution module 212 inputs the input data including the default prompt to the AI or another AI. The AI or another AI outputs the output data including the answer corresponding to the embedded representation calculated based on the input data including the default prompt. The output processing execution module 212 may input the input data including other information such as the user input information to the AI or another AI. The output processing execution module 212 may input, to the AI or another AI, the input data including other information such as information indicating what kind of API request has been transmitted.

The work support system 1 according to Modification Example 8 executes the output processing relating to the output to the user based on the execution result information and the AI or another AI. This enables the work support system 1 to perform the output corresponding to the execution result of the processing requested by the API request, thereby being able to further increase the convenience of the user. For example, even the user with no knowledge of API requests or little knowledge of API requests can confirm the output in an easily understandable form provided by the AI or another AI, and hence the work support system 1 can increase the convenience of the user.

The work support system 1 may include only the function of the output processing (for example, the execution result information acquisition module 211 and the output processing execution module 212) described in Modification Example 8 without including the function of generating an API request (for example, the API request generation module 204) described in the at least one embodiment. Such a work support system 1 can increase the convenience of the user by performing the output corresponding to the execution result of the processing requested by the API request. Such a work support system 1 is also within the scope of the present disclosure.

### 6-9. Modification Example 9

For example, the input data input to the AI or another AI in Modification Example 8 may include other information other than the information described in Modification Example 8. In Modification Example 9, a case in which input data including pre-execution information relating to a state exhibited before the processing requested by the API request is executed is input to the AI or another AI is taken as an example. The state is a state of the work support screen SC or a state of the data managed by the work support server 30. In Modification Example 9, a case in which the pre-execution information is a screenshot of the work support screen SC exhibited before the processing requested by the API request is executed is taken as an example.

The work support system 1 according to Modification Example 9 includes the pre-execution information acquisition module 213. The pre-execution information acquisition module 213 acquires the pre-execution information. For example, the pre-execution information acquisition module 213 acquires the pre-execution information from the user terminal 40 or another computer (for example, the work support server 30). When the pre-execution information is the screenshot of the work support screen SC as in Modification Example 9, the user terminal 40 acquires the screenshot of the work support screen SC when the user selects the button B or at any timing before that. The user terminal 40 transmits the pre-execution information, which is the screenshot, to the API request generation server 20. The pre-execution information acquisition module 213 receives the pre-execution information from the user terminal 40.

The output processing execution module 212 in Modification Example 9 executes the output processing further based on the pre-execution information. For example, the output processing execution module 212 inputs the input data including the pre-execution information to the AI or another AI. The AI or another AI calculates the embedded representation based on not only the execution result information but also the pre-execution information. The embedded representation reflects not only the execution result information but also information such as the screenshot indicated by the pre-execution information. The AI or another AI outputs the output data including the answer corresponding to the embedded representation calculated based on the input data including the pre-execution information.

For example, when the screenshot of the work support screen SC corresponds to the pre-execution information, the AI or another AI is assumed to be capable of image analysis. The AI or another AI executes image analysis on the screenshot, and outputs the output data including the answer corresponding to the embedded representation of the screenshot. For example, the AI or another AI outputs the output data based on the pre-execution information, to thereby output the output data including information relating to changes before and after the execution of the processing requested by the API request.

The work support system 1 according to Modification Example 9 executes the output processing further based on the pre-execution information. This enables the work support system 1 to perform the output corresponding to the state exhibited before the processing requested by the API request is executed, thereby being able to further increase the convenience of the user.

### 6-10. Modification Example 10

For example, in Modification Example 8 and Modification Example 9, the output processing execution module 212 executes the output processing by acquiring output content information relating to output content for the user. The output content information is all or part of the information included in the output data from the AI or another AI. In Modification Example 10, it is assumed that the output content information is not voice but text. In addition, the output to the user is performed by voice. Some specific content indicated by the output content information may be difficult to be converted into voice, and hence a delimiter may be inserted so as to make it easier to convert the specific content into voice.

The work support system 1 according to Modification Example 10 includes the output content correction module 214. The output content correction module 214 performs correction for the voice conversion on the output content information. The correction for the voice conversion is pre-processing for increasing the accuracy of the voice conversion. For example, the correction for the voice conversion may be processing for inserting a predetermined delimiter. The delimiter is a character for separating sentences. The delimiter may be a symbol. For example, the delimiter may be a slash, a backslash, a comma, a period, a punctuation mark, or another symbol. The delimiter may be a character that is not classified as a symbol. Data indicating which character is used as the delimiter is assumed to be stored in advance in the data storage unit 200.

For example, the output content correction module 214 inserts the delimiter at the end of each sentence in the text indicated by the output content information. The output content correction module 214 may also insert the delimiter at the end of each paragraph in the text indicated by the output content information. The output content correction module 214 transmits, to the voice conversion server 10, the output content information into which the predetermined delimiter has been inserted. The voice conversion server 10 receives, from the API request generation server 20, the output content information into which the predetermined delimiter has been inserted.

A correction method performed by the output content correction module 214 is not limited to the insertion of the delimiter. The correction for the voice conversion may be performed based on a publicly-known correction method. The output content correction module 214 may perform the correction on the output content information based on another correction method. For example, the other correction method may be normalization of the text indicated by the output content information (for example, extension of numbers or abbreviations or deletion or replacement of special characters), word conversion based on context understanding (for example, resolution of ambiguous words or linguistic analysis), or another method.

The voice conversion module 101 in Modification Example 10 performs the voice conversion based on the corrected output content information, and outputs the voice to the user. Modification Example 10 differs from the at least one embodiment in that the information to be converted into voice is the output content information corrected by the output content correction module 214, but the processing itself for converting text into voice may be the same as that in the at least one embodiment.

The work support system 1 according to Modification Example 10 executes the output processing by acquiring the output content information relating to the output content for the user. The work support system 1 performs the correction for the voice conversion on the output content information. The work support system 1 performs the voice conversion based on the corrected output content information, and outputs the voice to the user. This enables the work support system 1 to increase the accuracy of the voice conversion.

### 6-11. Other Modification Examples

For example, two or more of Modification Examples 1 to 10 may be combined.

For example, the functions described as being implemented by the voice conversion server 10 may be implemented by the API request generation server 20, the work support server 30, or the user terminal 40. The functions described as being implemented by the API request generation server 20 may be implemented by the voice conversion server 10, the work support server 30, or the user terminal 40. The functions described as being implemented by the work support server 30 may be implemented by the voice conversion server 10, the API request generation server 20, or the user terminal 40. The functions described as being implemented by the user terminal 40 may be implemented by the voice conversion server 10, the API request generation server 20, or the work support server 30. The respective functions may be distributed to a plurality of computers, or may be implemented by a single computer.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A work support system, which is configured to support work of a user, the work support system comprising at least one processor configured to:
acquire user input information relating to input of the user;
generate an API request for a transmission destination API among a plurality of APIs relating to the support of the work based on the user input information and an AI; and
transmit the API request to the transmission destination API.

2. The work support system according to claim 1, wherein the at least one processor is configured to:
acquire API specification information relating to a specification of the transmission destination API; and
generate the API request further based on the API specification information.

3. The work support system according to claim 1, wherein the at least one processor is configured to:
acquire a default prompt relating to generation of the API request, the default prompt being provided in advance; and
generate the API request further based on the default prompt.

4. The work support system according to claim 1, wherein the at least one processor is configured to:
acquire display screen information relating to a screen displayed on a user terminal when the input is performed; and
generate the API request further based on the display screen information.

5. The work support system according to claim 1, wherein the at least one processor is configured to:
acquire user attribute information relating to an attribute of the user; and
generate the API request further based on the user attribute information.

6. The work support system according to claim 1, wherein the at least one processor is configured to:
acquire the user input information each time the user performs new input; and
generate the API request further based on a history of the user input information.

7. The work support system according to claim 1, wherein the at least one processor is configured to generate the API request by supplementing a provisional API request output by the AI with supplement information relating to the support of the work.

8. The work support system according to claim 1, wherein the at least one processor is configured to:
acquire, based on the input of the user, correction content information relating to correction content of the API request;
generate a correction portion request, which is a post-correction request of a correction portion corresponding to the correction content in the API request that is pre-correction, based on the correction content information and the AI;
correct the API request by replacing the correction portion in the API request that is pre-correction by the correction portion request; and
transmit the corrected API request to the transmission destination API.

9. The work support system according to claim 1, wherein the at least one processor is configured to:
convert voice of the user into text based on term information relating to terms specific to the work support system; and
acquire the user input information indicating the text.

10. The work support system according to claim 1, wherein the at least one processor is configured to generate the API request in which each of APIs of each of a plurality of work support systems including the work support system is set as the transmission destination API.

11. The work support system according to claim 1, wherein the at least one processor is configured to:
acquire execution result information relating to an execution result of the API request; and
execute output processing relating to output to the user based on the execution result information and one of the AI or another AI.

12. The work support system according to claim 11, wherein the at least one processor is configured to:
acquire pre-execution information relating to a state exhibited before processing requested by the API request is executed; and
execute the output processing further based on the pre-execution information.

13. The work support system according to claim 11, wherein the at least one processor is configured to:
execute the output processing by acquiring output content information relating to output content for the user;
perform correction for voice conversion on the output content information; and
perform the voice conversion based on the corrected output content information, and output voice to the user.

14. A work support method, comprising:
acquiring user input information relating to input of a user of a work support system configured to support work of the user;
generating an API request for a transmission destination API among a plurality of APIs relating to the support of the work based on the user input information and an AI; and
transmitting the API request to the transmission destination API.

15. A non-transitory information storage medium having stored thereon a program for causing a computer of a work support system configured to support work of a user to:
acquire user input information relating to input of the user;
generate an API request for a transmission destination API among a plurality of APIs relating to the support of the work based on the user input information and an AI; and
transmit the API request to the transmission destination API.
